(19) United States
(12) Patent Application Publication
(10) Pub. No.: US 2009/0048374 A1
(43) Pub. Date: Feb. 19, 2009

(54) STABILIZER COMPOSITIONS FOR HALOGENATED POLYMERS WITH IMPROVED INITIAL COLOR AND IMPROVED COLOR MAINTENANCE

(75) Inventors: Stefan Fokken, Biberbach (DE); Frank Reichwald, Munchen (DE); Markus Willems, Munchen (DE)

Correspondence Address: BAINWOOD HUANG & ASSOCIATES LLC, 2 CONNECTOR ROAD, WESTBOROUGH, MA, 01581, US

(73) Assignee: BAERLOCHER GMBH, Unterschleissheim (DE)

(21) Appl. No.: 12/209,447

(22) Filed: Sep. 12, 2008

Related U.S. Application Data
(63) Continuation of application No. PCT/EP2007/000600, filed on Jan. 24, 2007.

(30) Foreign Application Priority Data
Mar. 15, 2006 (DE) 10 2006 011 933.9

(51) Int. Cl. C09K 15/16; C08K 5/3437; C08K 5/31; C08K 5/28; C09K 15/32

(52) U.S. Cl. 524/89; 252/403; 524/107; 524/100; 252/400.3; 524/147; 524/155; 524/178; 524/174; 524/190

(57) ABSTRACT

A stabilizer composition for halogenated polymers includes at least one compound from group A) and at least one compound from group B), group A) being composed of semicarbazides, carbazides, carbazones, and carbodiazones, and their salts, and group B) of guanidines and melamines, superacids and salts of superacids, epoxy and glycidyl compounds, 1,3-dicarbonyl compounds, polyols, sterically hindered amines, hydrotalcites, zeolites, and alkali metal aluminocarbonates, hydrocalumites, metal hydroxides, metal oxides, metal hydrogen carbonates, and metal carbonates, metal soaps, organotin compounds, organic phosphite esters, amino alcohols and hydroxyl-containing isocyanurates, α,β-unsaturated β-aminocarbonyl compounds, aminouracil compounds and aminothiouracil compounds, and compounds having at least one mercapto-functional, sp²-hybridized C atom. Polymers stabilized in accordance with the invention are notable in particular for improved initial color and also for improved color maintenance.

### CROSS REFERENCE TO RELATED APPLICATIONS

This Patent application is a Continuation of International Patent Application No. PCT/EP2007/000600 filed on Jan. 24, 2007, entitled “STABILIZER COMPOSITIONS FOR HALOGENATED POLYMERS WITH IMPROVED INITIAL COLOR AND IMPROVED COLOR MAINTENANCE”, the contents and teachings of which are hereby incorporated by reference in their entirety.

### BACKGROUND

The present invention relates to a stabilizer composition for halogenated polymers, comprising at least one compound from group A) and at least one compound from group B), group A) being composed of semicarbazides, carbazides, carbazones, and carbodiazones, and their salts, and group B) of guanidines and melamines, superacids and salts of superacids, epoxy and glycidyl compounds, 1,3-dicarbonyl compounds, polyols, sterically hindered amines, hydrotalcites, zeolites, and alkali metal aluminocarbonates, hydrocalumites, metal hydroxides, metal oxides, metal hydrogen carbonates, and metal carbonates, metal soaps, organotin compounds, organic phosphite esters, amino alcohols and hydroxyl-containing isocyanurates, α,β-unsaturated β-aminocarbonyl compounds, aminouracil compounds and aminothiouracil compounds, and compounds having at least one mercapto-functional, sp²-hybridized C atom. Polymers stabilized in accordance with the invention are notable in particular for improved initial color and also for improved color maintenance.

On thermal exposure during processing or in long-term use, halogenated plastics are known to have a tendency toward unwanted decomposition and degradation reactions. The degradation of halogenated polymers, in the case more particularly of PVC, produces hydrochloric acid, which is eliminated from the polymer strands, resulting in a discolored, unsaturated plastic having chromophoric polyene sequences.

One consequence of this that poses a particular problem is that halogenated polymers exhibit the Theological conditions that are necessary for processing only when the processing temperature is relatively high. In the case of unstabilized polymers, however, there is already marked decomposition of the polymer at such temperatures, leading not only to the unwanted color change described above but also to a change in the physical properties. Furthermore, the hydrochloric acid that is released from unstabilized halogenated polymers at such a processing temperature can lead to significant corrosion of the processing equipment. This process has a part to play more particularly when, during the processing of such halogenated polymers to moldings, by extrusion, for example, there are breaks in production and the polymer compound spends a prolonged period of time in the extruder. During this time, the aforementioned decomposition reactions may occur; as a result, the batch within the extruder becomes unusable and the extruder is possibly damaged.

Furthermore, polymers which are subject to such decomposition tend to form accretions on the processing equipment that are difficult to remove. The problems stated are commonly solved through the use of stabilizers, which are added to the halogenated polymer before or during processing. Examples of such known stabilizers include the lead stabilizers, barium stabilizers, cadmium stabilizers, organotin stabilizers, and also barium-cadmium, barium-zinc or calcium-zinc stabilizers.

As well as the problems outlined here, which occur within an early phase of the production of moldings from halogenated polymers, however, color stability and physical properties unchanged as far as possible are important for the service properties of such a molding over a prolonged period of time. Particularly in the case of moldings which are exposed to light, fluctuating temperatures or other external influences, an ongoing service life is accompanied by changes in the color and the physical properties, which may progress to such a stage that the molding becomes unusable. The use of the heavy metal stabilizers known from the prior art, however, is being refused by the processing industry and by the user, for a variety of reasons.

In order to counter the problem of the initial color and the problem of the color stability, use has been made in the past of organic stabilizer compositions, intended to counteract the changes in color and physical properties first during the phase of processing to the molding and second in long-term service.

Thus, for example, DE-A 1 569 056 describes a stabilized molding compound which is composed of a polymer or copolymer of vinyl chloride and a stabilizer combination comprising a mono- or diaromatically substituted urea or thiourea and an organic phosphite. The stabilizer combination may further comprise magnesium oxide or magnesium stearate. A problem affecting the molding compound described, however, is that its color stability is often deficient.

German patent DE 746 081 concerns a method of improving the heat resistance of halogenated high polymer compounds. It describes the stabilization of halogenated polymers with alkaline agents together with amines or carbamides which possess a mobile hydrogen atom that can be replaced by alkali. A problem affecting the method described, however, is that the initial color of the halogenated high polymer compounds described is deficient.

DE-C 36 36 146 concerns a method of stabilizing chlorinated resins. In the method described, a polymerized resin is admixed with an aminocrotonic ester and an epoxy compound that is free from metal ions. A disadvantage affecting the method described, however, is that the initial color of the resins in many cases does not meet heightened requirements.

U.S. Pat. No. 5,872,166 concerns PVC stabilizers which comprise an overbasic mixture of salts of unsubstituted or alkyl-substituted benzoic acids, where appropriate with one or more aliphatic fatty acids, a carbonate stabilizer or silicate stabilizer, and, if desired, one or more polyols having 2 to 10 OH groups. A disadvantage affecting the stabilizer described, however, is frequently the deficient stabilization in respect of the initial color.

### SUMMARY

Accordingly there was a need for a stabilizer composition for halogenated polymers that is free from heavy metals and yet produces an excellent initial color and color stability. A particular need was for a stabilizer composition which, in the production of moldings from halogenated polymers, ensures a good initial color and is also retained even during short-term breaks in production and the associated higher thermal exposure of the material. There was additionally a need for a stabilizer composition that also allows good color maintenance in the long-term service of a molding produced from a halogenated polymer.

It was an object of the present invention, accordingly, to provide stabilizer compositions for halogenated polymers that satisfy the needs identified above. A further object of the present invention was to provide a method of stabilizing halogenated polymers. Another object underlying the present invention was that of providing polymer compositions which exhibit good initial color and good color stability. An object of the present invention, furthermore, was to achieve the objectives identified above through the provision of a stabilizer composition which is also distinguished by good processing properties, in the context for example of the shaping extrusion of a polymer stabilized in accordance with the invention.

The objectives on which the invention is based are achieved by means of a stabilizer composition, a method of stabilizing halogenated polymers, and a polymer composition, as described in the text below.

The present invention provides a stabilizer composition comprising at least one compound from group A) and at least one compound from group B), group A) being composed of
a1) semicarbazides,
a2) carbazides,
a3) carbazones and
a4) carbodiazones,
and group B) being composed of
b1) guanidines and melamines,
b2) superacids and salts of superacids,
b3) epoxy and glycidyl compounds,
b4) 1,3-dicarbonyl compounds,
b5) polyols,
b6) sterically hindered amines,
b7) hydrotalcites, zeolites, and alkali metal aluminocarbonates,
b8) hydrocalumites,
b9) metal hydroxides, metal oxides, metal hydrogen carbonates, and metal carbonates,
b10) metal soaps,
b11) organotin compounds,
b12) organic phosphite esters,
b13) amino alcohols and hydroxyl-containing isocyanurates,
b14) α,β-unsaturated β-aminocarbonyl compounds,
b15) aminouracil compounds and aminothiouracil compounds, and
b16) compounds having at least one mercapto-functional, sp²-hybridized C atom.

“By stabilizer composition” is meant in the context of the present invention a composition that can be used to stabilize halogenated polymers. To achieve this stabilization effect, a stabilizer composition of the invention is generally mixed with a halogenated polymer it is intended to stabilize, and subsequently processed. It is also possible, though, to admix a stabilizer composition of the invention to the halogenated polymer for stabilization in the course of its processing.

### DETAILED DESCRIPTION

A stabilizer composition of the invention has at least two constituents. As a first constituent, a stabilizer composition of the invention comprises at least one compound from the group A) composed of semicarbazides and their salts, carbazides and their salts, carbazones and their salts, and carbodiazones and their salts.

Compounds from group A) that are suitable in accordance with the invention are, for example, semicarbazides of the formula I

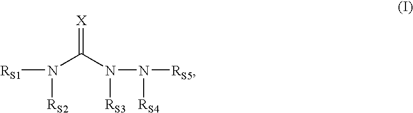

in which X is O, S or N—R_{S6} and in which the radicals R_{S1}, R_{S2}, R_{S3}, R_{S4}, R_{S5}, and, where X is N—R_{S6}, R_{S6} each independently of one another are hydrogen, an optionally substituted, linear or branched, saturated or unsaturated aliphatic alkyl radical having 1 to 44 C atoms, an optionally substituted, saturated or unsaturated cycloalkyl radical having 5 to 44 C atoms or an optionally substituted alkoxyl radical having 1 to 44 C atoms, or a linear or branched alkyl radical having 2 to 44 C atoms that is interrupted by one or more O atoms, or an optionally substituted aryl radical having 6 to 44 C atoms or an optionally substituted aralkyl radical having 7 to 44 C atoms or an optionally substituted acyl radical having 2 to 44 C atoms, or a cyano group —CN, or two or more of the radicals R_{S1}, R_{S2}, R_{S3}, R_{S4}, R_{S5} and, where X is N—R_{S6}, R_{S6} are joined to form an optionally substituted, saturated or unsaturated heterocyclic radical containing at least one N atom, an example being a cycloalkyl radical having 4 to 44 C atoms and containing at least one N atom, or an aryl radical having 4 to 44 C atoms and containing at least one N atom, or an optionally substituted aralkyl radical having 5 to 44 C atoms and containing at least one N atom.

In the context of further embodiments of the present invention, use is made in the stabilizer compositions of the invention of compounds of the formula I in which, for example, the radicals R_{S1}, R_{S2}, R_{S3}, R_{S4}, R_{S5}, and, where X is N—R_{S6}, R_{S6} are in each case independently of one another hydrogen, a linear or branched alkyl radical having 1 to 12 C atoms, such as methyl, ethyl, n-propyl, isopropyl, n-butyl, isobutyl, sec-butyl, tert-butyl, pentyl or hexyl, heptyl, octyl, 2-ethylhexyl, isooctyl, nonyl, decyl, undecyl or dodecyl, a linear or branched alkyl radical having 1 to 6 C atoms, which is substituted by OH groups, such as hydroxymethyl, hydroxyethyl, hydroxypropyl, hydroxybutyl, hydroxypentyl or hydroxyhexyl, a linear or branched alkyl radical having 1 to 6 C atoms which is substituted by NH₂ groups, such as aminomethyl, aminoethyl, aminopropyl, aminobutyl, aminopentyl or aminohexyl, a linear or branched alkyl radical having 1 to 6 C atoms which is substituted by cyano groups, such as cyanomethyl, cyanoethyl, cyanopropyl, cyanobutyl, cyanopentyl or cyanohexyl, a linear or branched alkyl radical having 2 to 10 C atoms which is interrupted by one or more O atoms —O—, such as methoxymethyl, methoxyethyl, methoxypropyl, methoxybutyl, methoxyhexyl, methoxyoctyl, ethoxymethyl, ethoxyethyl, ethoxypropyl, ethoxybutyl, ethoxyhexyl, ethoxyoctyl, n-propoxymethyl, n-propoxyethyl, n-propoxypropyl, n-propoxybutyl, n-propoxyhexyl, n-propoxyoctyl, isopropoxymethyl, isopropoxyethyl, isopropoxypropyl, isopropoxybutyl, isopropoxyhexyl, isopropoxyoctyl, n-butoxymethyl, n-butoxyethyl, n-butoxypropyl, n-butoxybutyl, n-butoxyhexyl, n-butoxyoctyl, isobutoxymethyl, isobutoxyethyl, isobutoxypropyl, isobutoxybutyl, isobutoxyhexyl, isobutoxyoctyl, tert-butoxymethyl, tert-butoxyethyl, tert-butoxypropyl, tert-butoxybutyl, tert-butoxyhexyl, tert-butoxyoctyl, —CH₂—O—CH₂—CH₂—O—CH₃, —CH₂—O—CH₂—CH₂—CH₂—O—CH₃, —CH₂—O—CH₂—CH₂—CH₂—CH₂—O—CH₃, —CH₂—CH₂—O—CH₂—CH₂—O—CH₂—CH₃ or —CH₂—CH₂—O—CH₂—CH₂—O—CH₂—CH₂—O—CH₂—CH₃, a cycloalkyl radical having 5 to 8 C atoms, such as cyclopentyl, cyclohexyl, cycloheptyl or cyclooctyl, an aryl radical having 6 to 10 C atoms, it being possible for the aryl radicals to be substituted, for example, by halogen atoms, methyl, ethyl, hydroxy, methoxy, ethoxy, amino or cyano groups, an aralkyl radical having 7 to 10 C atoms, such as benzyl, 1- or 2-phenylethyl, 3-phenylpropyl, α,α-dimethylbenzyl or 2-phenylisopropyl, it being possible for the aralkyl radicals to be substituted, for example, by halogen atoms, methyl, ethyl, hydroxy, methoxy, ethoxy, amino or cyano groups, an alkaryl radical having 7 to 10 C atoms, such as tolyl or mesityl, it being possible for the alkaryl radicals to be substituted, for example, by halogen atoms, methyl, ethyl, hydroxy, methoxy, ethoxy, amino or cyano groups, or an alkenyl radical having 3 to 6 C atoms, such a vinyl, allyl, methallyl, 1-butenyl, 2-butenyl, 3-butenyl, isobutenyl, 1-pentenyl, 2-pentenyl, 3-pentenyl, 4-pentenyl, 1-hexenyl, 2-hexenyl, 3-hexenyl, 4-hexenyl, 5-hexenyl, or one of the isomers thereof, or a cyano group.

In the context of preferred embodiments of the present invention, use is made in the stabilizer compositions of the invention of compounds of the general formula I in which at least one of the radicals R_{S1}, R_{S2}, R_{S3}, R_{S4}, R_{S5} or, where X is N—R_{S6}, R_{S6} is a cyano group and the radicals R_{S1}, R_{S2}, R_{S3}, R_{S4}, R_{S5}, and, where X is N—R_{S6}, R_{S6} that are not a cyano group are in each case independently of one another preferably hydrogen or a linear, unsubstituted alkyl radical having 1 to 44 C atoms, having for example 1, 2, 3, 4, 5, 6, 7, 8, 9 or 10 C atoms.

In accordance with further embodiments of the present invention, compounds of the formula I are used in which the radical R_{S1}, is a cyano group and the radicals R_{S2}, R_{S3}, R_{S4}, R_{S5}, and, where X is N—R_{S6}, R_{S6} are hydrogen. Provision is additionally made in accordance with the invention to use a compound of the formula I in which X is N—R_{S6}, the radical R_{S1}, is a cyano group, and the radicals R_{S2}, R_{S3}, R_{S4}, R_{S5}, and, where X is N—R_{S6}, R_{S6} are hydrogen.

In the context of further preferred embodiments of the present invention, use is made in the stabilizer compositions of the invention of compounds of the general formula I in which at least one of the radicals R_{S1}, R_{S2}, R_{S3}, R_{S4}, R_{S5} or, where X is N—R_{S6}, R_{S6} is a substituted or unsubstituted aryl radical and the radicals R_{S1}, R_{S2}, R_{S3}, R_{S4}, R_{S5}, and, where X is N—R_{S6}, R_{S6} that are not a substituted or unsubstituted aryl radical are in each case independently of one another preferably hydrogen or a linear, unsubstituted alkyl radical having 1 to 44 C atoms, having for example 1, 2, 3, 4, 5, 6, 7, 8, 9 or 10 C atoms.

In accordance with further embodiments, use is made in the stabilizer compositions of the invention of compounds of the general formula I in which the radical R_{S1}, is a substituted or unsubstituted aryl radical.

In accordance with one specific embodiment of the present invention, semicarbazides of the formula I are used which have as their radical R_{S1} a substituted or unsubstituted aryl radical. In the context of this specific embodiment, a stabilizer composition comprises as compound from group A), for example, a semicarbazide of the formula II:

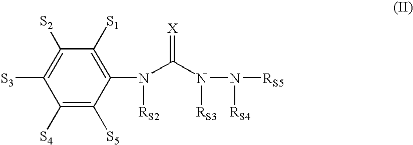

In formula II, X and the radicals R_{S2}, R_{S3}, R_{S4}, R_{S5}, and, where X is N—R_{S6}, R_{S6} have the same definition as defined below formula I, with, again, two or more of the radicals R_{S2}, R_{S3}, R_{S4}, R_{S5}, and, where X is N—R_{S6}, R_{S6} being possibly joined to form optionally substituted, saturated or unsaturated heterocyclic radicals containing at least one N atom. The radicals S1, S2, S3, S4, and S5 of the substituted or unsubstituted aryl radical in accordance with formula II are in each case independently of one another, for example, hydrogen, a linear or branched alkyl radical having 1 to 12 C atoms, such as methyl, ethyl, n-propyl, isopropyl, n-butyl, isobutyl, sec-butyl, tert-butyl, pentyl, hexyl, heptyl, octyl, 2-ethylhexyl, isooctyl, nonyl, decyl, undecyl or dodecyl, a linear or branched alkoxy radical having 1 to 12 C atoms, such as methoxy, ethoxy, n-propoxy, isopropoxy, n-butoxy, isobutoxy, tert-butoxy, a hydroxyl group, a substituted or unsubstituted amino group, a cyano group or a halogen atom, chlorine or bromine for example.

In the context of specific embodiments of the present invention, semicarbazides of the formula II are used in which the radicals R_{S2}, R_{S3}, R_{S4}, R_{S5}, and, when X is N—R_{S6}, R_{S6} are in each case independently of one another a linear, unsubstituted alkyl radical having 1 to 44 C atoms, having for example 1, 2, 3, 4, 5, 6, 7, 8, 9, or 10 C atoms, or are hydrogen.

Examples of substituted and unsubstituted aryl radicals in accordance with formula II are phenyl, tolyl, o-xylyl, m-xylyl-, p-xylyl-, 2,4,6-trimethylphenyl, aminophenyl, o-diaminophenyl, m-diaminophenyl, p-diaminophenyl, triaminophenyl, hydroxyphenyl, o-dihydroxyphenyl, m-dihydroxyphenyl, p-dihydroxyphenyl, and trihydroxyphenyl.

In accordance with further embodiments, use is made in the stabilizer compositions of the invention of compounds of the general formula I in which the radical R_{S1}, is a phenyl radical. The present invention hence also provides stabilizer compositions in which at least one 4-phenylsemicarbazide derivative is used.

In the context of further embodiments, a stabilizer composition comprises as a compound from group A), for example, a 4-phenylsemicarbazide derivative of the formula III:

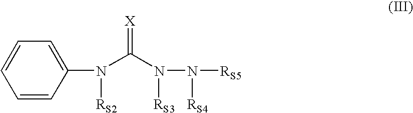

In formula III, X and the radicals R_{S2}, R_{S3}, R_{S4}, R_{S5}, and, where X is N—R_{S6}, R_{S6} have the same definition as defined below formula I, with, again, two or more of the radicals R_{S2}, R_{S3}, R_{S4}, R_{S5}, and, where X is N—R_{S6}, R_{S6} being possibly joined to form optionally substituted, saturated or unsaturated heterocyclic radicals containing at least one N atom. In the context of specific embodiments of the present invention, semicarbazides of the formula III are used in which the radicals R_{S2}, R_{S3}, R_{S4}, R_{S5}, and, when X is N—R_{S6}, R_{S6} are in each case hydrogen.

In the context of one preferred embodiment of the present invention, use is made as at least one compound from group A) of 4-phenylsemicarbazide, and so in this case the radicals R_{S2}, R_{S3}, R_{S4} and R_{S5} of formula III are each hydrogen, while X is O.

In the context of the present invention it is further possible and envisaged to use semicarbazides of formula I and, in particular, 4-phenylsemicarbazides of formula III in the form, for example, of salts or hydrates or complex compounds.

In the context of a further embodiment of the present invention, semicarbazides of formula I are used where two or more of the radicals R_{S1}, R_{S2}, R_{S3}, R_{S4}, R_{S5}, and, where X is N—R_{S6}, R_{S6} are joined to form an optionally substituted, saturated or unsaturated, heterocyclic radical containing at least one N atom, such as to form a cycloalkyl radical having 4 to 44 C atoms and containing at least one N atom, or an aryl radical having 4 to 44 C atoms and containing at least one N atom, or an optionally substituted aralkyl radical having 5 to 44 C atoms and containing at least one N atom.

Radicals suitable in accordance with the invention of heterocyclic compounds containing at least one N atom derive, for example, from derivatives of the compounds acridan, acridone, adenine, alloxane, azepine, aziridine, barbituric acid, Benedorm, benzimidazole, ε-caprolactam, carbazole, quinazolinone, quinazolone, cytosine, diaziridine, glutethimide, gramine, guanine, Evipan, uric acid, hydantoin, imidazole, indazole, indole, indophenine, indoxyl, isatin, isoindole, isothiazole, isoxazole, Luminal, luminol, morpholine, oxazine, oxaziridine, oxazole, oxazolidone, oxazoline, Δ²-oxazoline, oxindole, parabanic acid, pentazole, Phanodorm, phenanthridone, phenothiazine, phenoxazine, piperazine, piperidine, porphin, porphyrin, proline, pterine, purine, pyrazole, pyrimidine, pyrrole, pyrrolidine, pyrrolidone, Δ³-pyrroline, rhodanine, tetrazole, thiazine, thiadiazine, thiazole, thiouracil, 1,2,3-triazole, 1,2,4-triazole, thymine, tryptamine, tryptophan, uracil, Veronal, xanthine.

In the context of one preferred embodiment of the present invention, use is made of compounds having aromatic cycloalkyl radicals containing at least one N atom.

Further compounds suitable in accordance with the invention from group A) are, for example, carbazides of the formula IV:

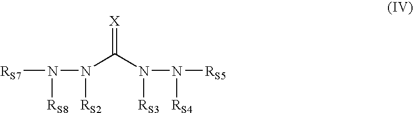

In formula IV, the radicals R_{S7} and R_{S8} have the same definition as the radical R_{S2}, and X and the radicals R_{S2}, R_{S3}, R_{S4}, R_{S5}, and, where X is N—R_{S6}, R_{S6} have the same definition as defined under formula I, where, again, two or more of the radicals R_{S2}, R_{S3}, R_{S4}, R_{S5}, where X is N—R_{S6}, R_{S6}, R_{S7}, R_{S8} may be joined to form optionally substituted, saturated or unsaturated heterocyclic radicals containing at least one N atom.

Further compounds suitable in accordance with the invention from group A) are, for example, carbazones of the formula V:

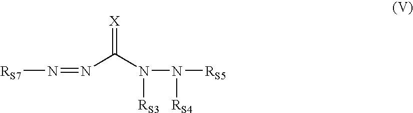

In formula V, the radicals R_{S7} have the same definition as the radical R_{S3}, and X and the radicals R_{S3}, R_{S4}, R_{S5}, and, where X is N—R_{S6}, R_{S6} have the same definition as defined under formula I, where, again, two or more of the radicals R_{S3}, R_{S4}, R_{S5}, where X is N—R_{S6}, R_{S6}, R_{S7} may be joined to form optionally substituted, saturated or unsaturated heterocyclic radicals containing at least one N atom.

Further compounds suitable in accordance with the invention from group A) are, for example, carbodiazones of the formula VI:

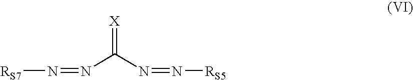

In formula VI, the radicals R_{S7} have the same definition as the radical R_{S3}, and X and the radicals R_{S5}, and, where X is N—R_{S6}, R_{S6} have the same definition as defined under formula I, where, again, two or more of the radicals R_{S5}, where X is N—R_{S6}, R_{S6}, R_{S7} may be joined to form optionally substituted, saturated or unsaturated heterocyclic radicals containing at least one N atom.

The fraction of a compound from group A) of the invention or of a mixture of two or more compounds from group A) of the invention as a proportion of the stabilizer composition of the invention is about 0.01% to about 99.99% by weight, for example, about 0.1% to about 90% by weight or about 1% to about 85% by weight or about 5% to about 80% by weight or about 10% to about 75% by weight. Additionally suitable amounts are situated for instance in a range from about 15% to about 70% by weight, based in each case on the overall stabilizer composition. Where a stabilizer composition of the invention comprises more than two constituents, the fraction of a compound from group A) or of a mixture of two or more compounds from group A) as a proportion of such a stabilizer composition of the invention may be situated, for example, in the range from about 0.01% to about 99.99% by weight, for example, about 0.05% to about 50% by weight or about 0.1% to about 40% by weight or about 0.2% to about 30% by weight or about 0.3% to about 25% by weight or about 0.4% to about 20% by weight or about 0.5% to about 17% by weight or about 0.6% to about 15% by weight or about 0.7% to about 10% by weight, based in each case on the overall stabilizer composition.

Besides at least one compound from group A), a stabilizer composition of the invention comprises as a second constituent at least one compound from the group B) composed of guanidines and melamines, superacids and salts of superacids, epoxy and glycidyl compounds, 1,3-dicarbonyl compounds, polyols, sterically hindered amines, hydrotalcites, zeolites, and alkali metal aluminocarbonates, hydrocalumites, metal hydroxides, metal oxides, metal hydrogen carbonates, and metal carbonates, metal soaps, organotin compounds, organic phosphite esters, amino alcohols and hydroxyl-containing isocyanurates, α,β-unsaturated β-aminocarbonyl compounds, aminouracil compounds and compounds having at least one mercapto-functional, sp²-hybridized C atom.

Compounds suitable in accordance with the invention from group B) are, for example, guanidines of the formula VII

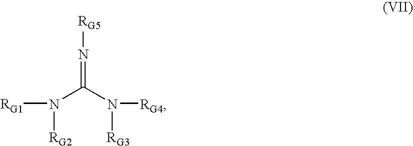

in which the radicals R_{G1}, R_{G2}, R_{G3}, R_{G4}, and R_{G5} in each case independently of one another are hydrogen, an optionally substituted, linear or branched, saturated or unsaturated aliphatic alkyl radical having 1 to 44 C atoms, an optionally substituted, saturated or unsaturated cycloalkyl radical having 5 to 44 C atoms or an optionally substituted alkoxy radical having 1 to 44 C atoms, or a linear or branched alkyl radical having 2 to 44 C atoms which is interrupted by one or more O atoms, or an optionally substituted aryl radical having 6 to 44 C atoms or an optionally substituted aralkyl radical having 7 to 44 C atoms or an optionally substituted acyl radical having 2 to 44 C atoms, or a cyano group —CN, or two or more of the radicals R_{G1}, R_{G2}, R_{G3}, R_{G4}, R_{G5} are joined to form an optionally substituted, saturated or unsaturated heterocyclic radical containing at least one N atom, for example, a cycloalkyl radical having 4 to 44 C atoms and containing at least one N atom or an aryl radical having 4 to 44 C atoms and containing at least one N atom or an optionally substituted aralkyl radical having 5 to 44 C atoms and containing at least one N atom.

In the context of further embodiments of the present invention, use is made in the stabilizer compositions of the invention of compounds of the formula VII in which, for example, the radicals R_{G1}, R_{G2}, R_{G3}, R_{G4}, R_{G5} in each case independently of one another are hydrogen, a linear or branched alkyl radical having 1 to 12 C atoms, such as methyl, ethyl, n-propyl, isopropyl, n-butyl, isobutyl, sec-butyl, tert-butyl, pentyl or hexyl, heptyl, octyl, 2-ethylhexyl, isooctyl, nonyl, decyl, undecyl or dodecyl, a linear or branched alkyl radical having 1 to 6 C atoms, which is substituted by OH groups, such as hydroxymethyl, hydroxyethyl, hydroxypropyl, hydroxybutyl, hydroxypentyl or hydroxyhexyl, a linear or branched alkyl radical having 1 to 6 C atoms which is substituted by NH₂ groups, such as aminomethyl, aminoethyl, aminopropyl, aminobutyl, aminopentyl or aminohexyl, a linear or branched alkyl radical having 1 to 6 C atoms which is substituted by cyano groups, such as cyanomethyl, cyanoethyl, cyanopropyl, cyanobutyl, cyanopentyl or cyanohexyl, a linear or branched alkyl radical having 2 to 10 C atoms which is interrupted by one or more O atoms, such as methoxymethyl, methoxyethyl, methoxypropyl, methoxybutyl, methoxyhexyl, methoxyoctyl, ethoxymethyl, ethoxyethyl, ethoxypropyl, ethoxybutyl, ethoxyhexyl, ethoxyoctyl, n-propoxymethyl, n-propoxyethyl, n-propoxypropyl, n-propoxybutyl, n-propoxyhexyl, n-propoxyoctyl, isopropoxymethyl, isopropoxyethyl, isopropoxypropyl, isopropoxybutyl, isopropoxyhexyl, isopropoxyoctyl, n-butoxymethyl, n-butoxyethyl, n-butoxypropyl, n-butoxybutyl, n-butoxyhexyl, n-butoxyoctyl, isobutoxymethyl, isobutoxyethyl, isobutoxypropyl, isobutoxybutyl, isobutoxyhexyl, isobutoxyoctyl, tert-butoxymethyl, tert-butoxyethyl, tert-butoxypropyl, tert-butoxybutyl, tert-butoxyhexyl, tert-butoxyoctyl, —CH₂—O—CH₂—CH₂—O—CH₃, —CH₂—O—CH₂—CH₂—CH₂—O—CH₃, —CH₂—O—CH₂—CH₂—CH₂—CH₂—O—CH₃, —CH₂—CH₂—O—CH₂—CH₂—O—CH₂—CH₃ or —CH₂—CH₂—O—CH₂—CH₂—O—CH₂—CH₂—O—CH₂—CH₃, a cycloalkyl radical having 5 to 8 C atoms, such as cyclopentyl, cyclohexyl, cycloheptyl or cyclooctyl, an aralkyl radical having 7 to 10 C atoms, such as benzyl, 1- or 2-phenylethyl, 3-phenylpropyl, α,α-dimethylbenzyl or 2-phenylisopropyl, it being possible for the aralkyl radicals mentioned to be substituted, for example, by halogen atoms, methyl, ethyl, hydroxy, methoxy, ethoxy, amino or cyano groups, an alkaryl radical having 7 to 10 C atoms, such as tolyl or mesityl, it being possible for the alkaryl radicals to be substituted, for example, by halogen atoms, methyl, ethyl, hydroxy, methoxy, ethoxy, amino or cyano groups, or an alkenyl radical having 3 to 6 C atoms, such a vinyl, allyl, methallyl, 1-butenyl, 2-butenyl, 3-butenyl, isobutenyl, 1-pentenyl, 2-pentenyl, 3-pentenyl, 4-pentenyl, 1-hexenyl, 2-hexenyl, 3-hexenyl, 4-hexenyl, 5-hexenyl, or one of the isomers thereof, or a cyano group.

In the context of one preferred embodiment of the present invention, use is made in the stabilizer compositions of the invention of compounds of the general formula VII in which at least one of the radicals R_{G1}, R_{G2}, R_{G3}, R_{G4} or R_{G5} is a cyano group. Examples are compounds of the formula VII in which the radicals R_{G1}, R_{G2}, R_{G3}, R_{G4} and R_{G5}, or the radicals R_{G1}, R_{G2}, R_{G3} and R_{G4}, or the radicals R_{G1}, R_{G2}, R_{G4}, and R_{G5}, or the radicals R_{G1}, R_{G2}, and R_{G4}, or the radicals R_{G1}, R_{G2}, and R_{G5}, or the radicals R_{G1}, and R_{G2}, or the radicals R_{G1}, R_{G4}, and R_{G5}, or the radicals the radicals R_{G1} and R_{G4}, are in each case a cyano group and the radicals R_{G1}, R_{G2}, R_{G3}, R_{G4}, and R_{G5} that are not a cyano group are preferably hydrogen or a linear, unsubstituted alkyl radical having 1 to 44 C atoms, having for example 1, 2, 3, 4, 5, 6, 7, 8, 9 or 10 C atoms.

In the context of specific embodiments a stabilizer composition comprises cyanoguanidines of the formula VIII:

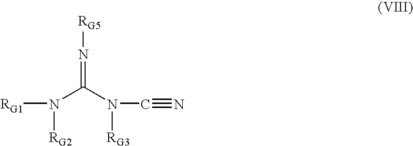

In formula VIII the radicals R_{G1}, R_{G2}, R_{G3}, and R_{G5} have the same definition as defined under formula VII, and, again, two or more of the radicals R_{G1}, R_{G2}, R_{G3}, R_{G5} may be joined to form optionally substituted, saturated or unsaturated heterocyclic radicals containing at least one N atom. In the context of specific embodiments of the present invention, cyanoguanidines are used in which the radical R_{G1} is a linear, unsubstituted alkyl radical having 1 to 44 C atoms, having for example 1, 2, 3, 4, 5, 6, 7, 8, 9 or 10 C atoms, and the radicals R_{G2}, R_{G3}, and R_{G5} are each hydrogen. Examples are N-cyano-N′-methylguanidine, N-cyano-N′-ethylguanidine, N-cyano-N′-propylguanidine, N-cyano-N′-butylguanidine, N-cyano-N′-pentylguanidine, and N-cyano-N′-hexylguanidine.

In the context of one preferred embodiment of the present invention, cyanoguanidine is used, and thus in this case the radicals R_{G1}, R_{G2}, R_{G3}, and R_{G5} of the formula VIII are each hydrogen.

In the context of the present invention it is additionally possible and envisaged to use guanidines, and in particular cyanoguanidines, in the form for example of salts or hydrates or complex compounds. Examples of such compounds are guanidine monohydrate, guanidinium fluoride, guanidinium chloride, guanidinium bromide, guanidinium iodide, guanidinium nitrate, guanidinium sulfate, guanidinium phosphate, guanidinium perchlorate, guanidinium picrate, guanidinium oxalate, cyanoguanidine monohydrate, cyanoguanidinium fluoride, cyanoguanidinium chloride, cyanoguanidinium bromide, cyanoguanidinium iodide, cyanoguanidinium nitrate, cyanoguanidinium sulfate, cyanoguanidinium phosphate, cyanoguanidinium perchlorate, cyanoguanidinium oxalate.

In the context of a further embodiment of the present invention, guanidines of formula VII are used in which two or more of the radicals R_{G1}, R_{G2}, R_{G3}, R_{G4}, R_{G5} are joined to form an optionally substituted, saturated or unsaturated heterocyclic radical containing at least one N atom, such as a cycloalkyl radical having 4 to 44 C atoms and containing at least one N atom, or an aryl radical having 4 to 44 C atoms and containing at least one N atom, or an optionally substituted aralkyl radical having 5 to 44 C atoms and containing at least one N atom.

Radicals suitable in accordance with the invention of heterocyclic compounds containing at least one N atom derive, for example, from derivatives of the compounds acridan, acridone, adenine, alloxane, azepine, aziridine, barbituric acid, Benedorm, benzimidazole, ε-caprolactam, carbazole, quinazolinone, quinazolone, cytosine, diaziridine, glutethimide, gramine, guanine, Evipan, uric acid, hydantoin, imidazole, indazole, indole, indophenine, indoxyl, isatin, isoindole, isothiazole, isoxazole, Luminal, luminol, morpholine, oxazine, oxaziridine, oxazole, oxazolidone, oxazoline, Δ²-oxazoline, oxindole, parabanic acid, pentazole, Phanodorm, phenanthridone, phenothiazine, phenoxazine, piperazine, piperidine, porphin, porphyrin, proline, pterine, purine, pyrazole, pyrimidine, pyrrole, pyrrolidine, pyrrolidone, Δ³-pyrroline, rhodanine, tetrazole, thiazine, thiadiazine, thiazole, thiouracil, 1,2,3-triazole, 1,2,4-triazole, thymine, tryptamine, tryptophan, uracil, Veronal, xanthine.

In the context of one preferred embodiment, use is made of guanidines having aromatic cycloalkyl radicals containing at least one N atom.

Guanidines suitable according to one specific embodiment of the present invention, having at least one heterocyclic radical of the formula VII containing at least one N atom, are, for example, imidazole compounds of the formula IX:

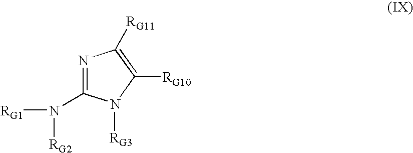

In formula IX the radicals R_{G10} and R_{G11} have the same definition as the radical R_{G1}, and the radicals R_{G1}, R_{G2} and R_{G3} have the same definition as defined under formula VII, with, again, it being possible for two or more of the radicals R_{G1}, R_{G2}, R_{G3}, R_{G10}, R_{G11} to be joined to form optionally substituted, saturated or unsaturated heterocyclic radicals containing at least one N atom.

Further guanidines suitable in accordance with the invention in the context of specific embodiments and containing at least one heterocyclic radical of formula VII, containing at least one N atom, are, for example, compounds of the formula X:

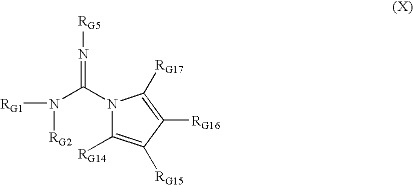

In formula X the radicals R_{G1}, R_{G2}, and R_{G5} have the same definition as defined under formula VII, it being possible for two or more of the radicals R_{G1}, R_{G2}, R_{G5} to be joined to form optionally substituted, saturated or unsaturated heterocyclic radicals containing at least one N atom, and the radicals R_{G14}, R_{G15}, R_{G16}, and R_{G17} in each case independently of one another are hydrogen, an optionally substituted, linear or branched, saturated or unsaturated aliphatic alkyl radical having 1 to 44 C atoms, an optionally substituted, saturated or unsaturated cycloalkyl radical having 5 to 44 C atoms, or an optionally substituted aryl radical having 6 to 44 C atoms or an optionally substituted aralkyl radical having 7 to 44 C atoms or an optionally substituted acyl radical having 2 to 44 C atoms, or a cyano group —CN, or two or more of the radicals R_{G14}, R_{G15}, R_{G16}, R_{G17} are joined to form an optionally substituted, saturated or unsaturated cycloalkyl radical having 5 to 44 C atoms or an aryl radical having 6 to 44 C atoms or an aralkyl radical having 7 to 44 C atoms. Further compounds suitable in accordance with the invention from group B) are, for example, melamines of the formula XI:

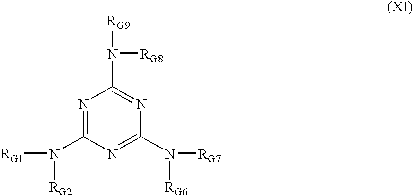

In formula XI the radicals R_{G6}, R_{G7}, R_{G8}, and R_{G9} have the same definition as the radical R_{G1}, and the radicals R_{G1} and R_{G2} have the same definition as defined under formula VII, where, again, two or more of the radicals R_{G1}, R_{G2}, R_{G6}, R_{G7}, R_{G8}, R_{G9} may be joined to form optionally substituted, saturated or unsaturated, heterocyclic radicals containing at least one N atom.

The fraction of a guanidine of the invention or of a melamine of the invention or of a mixture of two or more thereof as a proportion of the stabilizer composition of the invention is about 0.01% to about 99.99% by weight, for example, about 0.1% to about 90% by weight or about 1% to about 85% by weight or about 5% to about 80% by weight or about 10% to about 70% by weight. Additionally suitable amounts are situated, for instance, in a range from about 15% to about 65% by weight or about 20% to about 60% by weight, based in each case on the overall stabilizer composition. Where a stabilizer composition of the invention comprises more than two constituents, the fraction of a guanidine of the invention or of a melamine of the invention or of a mixture of two or more thereof as a proportion of such a stabilizer composition of the invention may be situated, for example, in the range from about 0.01% to about 99.99% by weight, for example, about 0.05% to about 50% by weight or about 0.1% to about 40% by weight or about 1% to about 30% by weight or about 1.5% to about 20% by weight or about 2% to about 15% by weight, based in each case on the overall stabilizer composition.

Likewise suitable in accordance with the invention as at least one compound in accordance with the group B) are, for example, Brönstedt superacids or salts of Brönstedt superacids or mixtures of two or more thereof. In the context of the present text the terms “Brönstedt superacid” and “superacid” are used synonymously. By a “superacid” is meant in the context of the present invention, for example, an acid which is more acidic than pure sulfuric acid.

The acidity of a superacid of the invention may be determined, for example, as gas-phase acidity in the gas phase in accordance with the equilibrium HA [symbol] H⁺+A⁻, and quantified by the free enthalpy ΔG_{acid} corresponding to this equilibrium. In this context reference may be made by way of example to I. A. Koppel et al. in J. Am. Chem. Soc., 1994, 116, 3047-3057. In certain cases it is also possible to calculate the free enthalpy ΔG_{acid}. Here reference may be made, by way of example, to I. A. Koppel et al. in J. Am. Chem. Soc., 2000, 122, 5114-5124.

A superacid suitable in accordance with the invention has for example a ΔG_{acid} of less than or equal to 320 kcal/mol or less than or equal to 316 kcal/mol or less than or equal to 312 kcal/mol or less than or equal to 310 kcal/mol or less than or equal to 308 kcal/mol or less than or equal to 307 kcal/mol or less than or equal to 306 kcal/mol or less than or equal to 305 kcal/mol.

For example, a stabilizer composition in accordance with the present invention comprises, as at least one superacid, a halogen-containing oxyacid, more particularly perchloric acid, or, as at least one salt of a superacid, a salt of a halogen-containing oxyacid, more particularly a perchlorate of the general formula M(ClO₄)ₖ, where M is a suitable organic or inorganic cation. In accordance with the valence of M, the index k is the number 1, 2 or 3. Inorganic cations M suitable in accordance with the invention are, for example, Li, Na, K, Mg, Ca, Sr, Zn, Al, La, Ce or NH₄.

Organic cations M suitable in accordance with the invention include, for example, organic onium ions, the term “organic onium ion” referring in the context of the present text to ammonium, sulfonium or phosphonium ions which in each case carry at least one organic radical. A corresponding onium salt in accordance with the present invention may, depending on the nature of the onium group, carry 1, 2, 3 or 4 organic radicals. These organic radicals may be joined, for example, via a C—X link, where X is N, S or P, to a positively charged N, S or P atom of an onium ion of the invention. It is also possible, though, for the organic radicals to be joined via a further heteroatom, such as an O atom, for example, to a positively charged N, S or P atom of an onium ion of the invention.

One onium perchlorate which is suitable in the context of the present invention as a constituent of a stabilizer composition of the invention has, for example, a positively charged N, S or P atom or two or more such positively charged N, S or P atoms, or mixtures of two or more of the stated positively charged atom types.

Suitability as onium perchlorates is possessed in the context of the present invention by compounds which on the N, S or P atom carry at least one organic radical and not more than the maximum possible number of organic radicals. If an onium perchlorate suitable in accordance with the invention carries fewer organic radicals than are necessary for the formation of a positively charged onium ion, then the positive charge is generated, in a typical way known to the skilled worker, by means, for example, of protonation with a suitable acid, and so in this case the corresponding onium perchlorate carries not only an organic radical but also at least one proton.

In accordance with the invention, therefore, suitability as onium perchlorates is possessed by compounds which have a positive charge by virtue of protonation reactions. It is also possible, though, in the context of the stabilizer compositions of the invention, to use onium perchlorates which have a positive charge by virtue of an alkylation or peralkylation reaction. Examples of compounds of this kind are tetraalkylammonium, trialkylsulfonium or tetraalkylphosphonium perchlorates. In the context of the present invention, however, it is also envisaged that an onium perchlorate which is suitable in accordance with the invention has an aryl, alkaryl, cycloalkyl, alkenyl, alkynyl or cycloalkenyl radical. In accordance with the invention it is also possible and envisaged that an onium salt which can be used in the context of the stabilizer composition of the invention has two or, where appropriate, more different types of substituents, such as an alkyl and a cycloalkyl radical or an alkyl and an aryl radical, for example.

In the context of the present invention it is also possible and envisaged that an onium salt which can be used in the context of a stabilizer composition of the invention has substituents which in turn are substituted by one or more functional groups. “Functional groups” in this context are groups which improve, or at least do not impair, or not substantially impair, the effects of the stabilizer composition or stabilizer composition. Corresponding functional groups may be, for example, NH groups, NH₂ groups, OH groups, SH groups, ester groups, ether groups, thioether groups, isocyanurate groups or keto groups, or mixtures of two or more of these.

Compounds which can be used as ammonium perchlorates in the context of the present invention are in principle all compounds which through corresponding reaction of suitable reactants lead to an ammonium perchlorate. Ammonium perchlorates which can be used in accordance with the invention may in this context be obtained, for example, by corresponding reaction of amines such as alkylmonoamines, alkylenediamines, alkylpolyamines, or secondary or tertiary amines or amides.

Suitable ammonium perchlorates therefore derive, for example, from monoamino compounds having 2 to about 40, such as 6 to about 20, C atoms, or from diamino compounds having 2 to about 40, such as 6 to about 20, C atoms, or from triamino compounds having 2 to about 40, such as 6 to about 20, C atoms. Use may additionally be made in accordance with the invention, for example, of substituted amines having 2 to about 2° C. atoms.

Suitable monoamines have, for example, one primary, one secondary or one tertiary amino group. Examples thereof are mono-, di- or triethylamine, mono-, di- or tri-n-propylamine, mono-, di- or triisopropylamine, mono-, di- or tri-n-butylamine, mono-, di- or tri-sec-butylamine, mono-, di- or tri-tert-butylamine or mono-, di- or trioctylamine, N-methyl-, N-ethyl-, N-cyclohexylmorpholine, dimethylcyclohe-xylamine, dimethylbenzylamine, trimethylamine, 1-azabicyclo[3.3.0]octane. Suitable diamines have, for example, two primary, two secondary, two tertiary or one primary and one secondary or one primary and one tertiary or one secondary and one tertiary amino group. Examples thereof are diaminoethane, the isomeric diaminopropanes, the isomeric diaminobutanes, the isomeric diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, 2-(N,N-dimethylamino)-1-aminoethane, dimorpholinodiethyl ether, 1,4-diazabicyclo[2.2.2]octane, N,N,N′,N′-tetra-methylethylenediamine, N,N,N′,N′-tetramethylbutanediamine, N,N,N′,N′-tetramethylhexane-1,6-diamine, tetramethyldiamino ethyl ether, di(4-N,N-dimethylaminocyclohexyl)methane, 1,2-dimethylimidazole, N,N′-dimethylpiperazine, hydrazine, hydrazine hydrate. Suitable triamines have, for example, three primary, three secondary, three tertiary or two primary and one secondary or one tertiary, two secondary and one primary or tertiary, two tertiary and one primary or secondary. Examples thereof are diethylenetriamine, 1,8-diamino-4-aminomethyloctane, pentamethyldiethylenetriamine. Suitability is further possessed by, for example, bis(dimethylaminopropyl)urea.

Likewise suitable are aliphatic amino alcohols having 2 to about 40, preferably 2 to about 2° C. atoms, examples being ethanolamine, propanolamine, butanolamine, pentanolamine, 1-amino-3,3-dimethylpentan-5-ol, 2-aminohexane-2′,2″-diethanolamine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentanemethanol, 2-amino-2-ethyl-1,3-propanediol, 2-(dimethylaminoethoxy)ethanol, diethanolamine, dipropanolamine, dibutanolamine, dipentanolamine, triethanolamine, tripropanolamine, triisopropanolamine, tributanolamine, tripentanolamine, aromatic-aliphatic or aromatic-cycloaliphatic amino alcohols having 6 to about 2° C. atoms, the aromatic structures used being heterocyclic or isocyclic ring systems such as naphthalene derivatives or, in particular, benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol, and also mixtures of two or more such compounds.

In the context of one further embodiment of the present invention, ammonium perchlorates used are the perchlorates of heterocyclic compounds which possess a cyclic ring system having amino groups.

A stabilizer composition of the invention may comprise, for example, only one halogen-containing oxyacid or only one salt of a halogen-containing oxyacid. In the context of the present invention, however, it is also possible and envisaged that a stabilizer composition of the invention comprises a mixture of two or more halogen-containing oxyacids or a mixture of two or more salts of halogen-containing oxyacids, or a mixture of at least one halogen-containing oxyacid and at least one salt of a halogen-containing oxyacid.

In the context of one specific embodiment, a stabilizer composition in accordance with the present invention comprises perchloric acid as at least one superacid, or a salt of perchloric acid as at least one salt of a superacid, such as NaClO₄ or LiClO₄, for example.

In accordance with one further embodiment a stabilizer composition in accordance with the present invention comprises a sulfonic acid or alkanesulfonic acid as at least one superacid, or a salt of a sulfonic acid or an alkanesulfonic acid as at least one salt of a superacid. Sulfonic acids suitable in accordance with the invention satisfy, for example, the formula XII

Hₛ(R_{S}—(SO₃)ₛ) (XII).

Salts of sulfonic acids that are suitable in accordance with the invention satisfy, for example, the formula XIII

(Mₛ)_{s/g}((R_{S}—(SO₃)ₛ) (XIII).

In the formulae XII and XIII:
R_{S} is a substituted, linear or branched, alkyl radical having 1 to 44 C atoms, a substituted cycloalkyl radical having 6 to 44 C atoms, a substituted aryl radical having 6 to 44 C atoms, a substituted alkaryl radical having 7 to 44 C atoms or a substituted aralkyl radical having 7 to 44 C atoms, one substituent carrying at least one electron-withdrawing group or group which stabilizes a sulfonic acid anion, an example being F, NO₂ or OH,
s is an integer from 1 to about 10, such as 1, 2, 3, or 4,
H is a proton and Mₛ is a cation of the elements Li, Na, K, Rb, Cs, Be, Mg, Ca, Sr, Ba, Al or of the transition elements, or an ammonium ion NH₄⁺ or a organic cation, and
g is the charge number of the cation.

Organic cations Mₛ suitable in accordance with the invention include, for example, organic onium ions, the term “organic onium ion” in the context of the present text, and already described therein elsewhere, referring to ammonium, sulfonium or phosphonium ions, which in each case carry at least one organic radical.

An organic onium sulfonate in accordance with the present invention is any sulfonate of the invention which has at least one organic onium ion as cation Mₛ. An organic ammonium sulfonate in accordance with the present invention is any sulfonate of the invention which has at least one organic ammonium ion as cation Mₛ.

Suitable organic cations Mₛ of sulfonates suitable in accordance with the invention are, for example, organic ammonium ions which carry at least one organic radical. A corresponding organic ammonium ion in accordance with the present invention may carry 1, 2, 3 or 4 organic radicals. The organic radicals may be joined, for example, via a C—N linkage to the positively charged N atom of an ammonium ion of the invention. It is also possible, though, for the organic radicals to be joined via a further heteroatom, such as an O atom, to the positively charged N atom of an ammonium ion of the invention.

One organic ammonium sulfonate which is suitable in the context of the present invention as a constituent of a stabilizer composition of the invention has, for example, a positively charged N atom or two or more such positively charged N atoms, or mixtures of two or more of the stated positively charged N atoms.

Suitability as organic cations Mₛ is possessed in the context of the present invention by ions which on an N atom carry at least one organic radical and not more than the maximum possible number of organic radicals. If an organic cation Mₛ suitable in accordance with the invention carries on an N atom fewer organic radicals than are necessary for the formation of a positively charged organic cation Mₛ, then the positive charge is generated, in a typical way known to the skilled worker, by means, for example, of protonation with a suitable acid, and so in this case the corresponding organic cation Mₛ carries not only an organic radical but also at least one proton.

In accordance with the invention, therefore, suitability as organic cations Mₛ is possessed by those which have a positive charge by virtue of protonation reactions. It is also possible, though, in the context of the stabilizer compositions of the invention, to use organic cations Mₛ which have a positive charge by virtue of an alkylation or peralkylation reaction. In the context of the present invention, however, it is also envisaged that an organic cation Mₛ which is suitable in accordance with the invention has an aryl, alkaryl, cycloalkyl, alkenyl, alkynyl or cycloalkenyl radical. In accordance with the invention it is also possible and envisaged that an organic cation Mₛ which can be used in the context of the stabilizer composition of the invention has two or, where appropriate, more different types of substituents, such as an alkyl and a cycloalkyl radical or an alkyl and an aryl radical, for example.

In the context of the present invention it is also possible and envisaged that an organic cation Mₛ which can be used in the context of a stabilizer composition of the invention has substituents which in turn are substituted by one or more functional groups. “Functional groups” in this context are groups which improve, or at least do not impair, or not substantially impair, the effects of the stabilizer composition or stabilizer composition. Corresponding functional groups may be, for example, NH groups, NH₂ groups, OH groups, SH groups, ester groups, ether groups, thioether groups, isocyanurate groups or keto groups, or mixtures of two or more of these.

Compounds which can be used as organic ammonium sulfonates in the context of the present invention are in principle all compounds which through corresponding reaction of suitable reactants lead to an organic ammonium sulfonate. Organic ammonium sulfonates which can be used in accordance with the invention may in this context be obtained, for example, by corresponding reaction of amines such as alkylmonoamines, alkylenediamines, alkylpolyamines, or secondary or tertiary amines or amides.

Suitable organic ammonium sulfonates therefore derive, for example, from monoamino compounds having 2 to about 40, such as 6 to about 20, C atoms, or from diamino compounds having 2 to about 40, such as 6 to about 20, C atoms, or from triamino compounds having 2 to about 40, such as 6 to about 20, C atoms. Use may additionally be made in accordance with the invention, for example, of substituted amines having 2 to about 2° C. atoms.

Suitable monoamines, diamines, triamines, and also aliphatic amino alcohols and aromatic-cycloaliphatic amino alcohols, correspond to the compounds specified on pages 35 and 36.

In the context of a further embodiment of the present invention, ammonium sulfonates used are the sulfonates of heterocyclic compounds which possess a cyclic ring system having amino groups.

In the context of a further embodiment, a stabilizer composition according to the present invention is distinguished by the fact that at least one superacid is an alkanesulfonic acid, or at least one salt of a superacid is a salt of an alkanesulfonic acid, such as, for example, HSO₃CF₃, HSO₃C₂F₅, HSO₃C₃F₇, HSO₃C₄F₉, HSO₃C₅F₁₁, HSO₃C₆F₁₃, HSO₃C₇F₁₅, HSO₃C₈F₁₇, HSO₃C₉F₁₉, HSO₃C₁₀F₂₁, HSO₃C₁₁F₂₃, HSO₃C₁₂F₂₅, LiSO₃CF₃, LiSO₃C₂F₅, LiSO₃C₃F₇, LiSO₃C₄F₉, LiSO₃C₅F₁₁, LiSO₃C₆F₁₃, LiSO₃C₇F₁₅, LiSO₃C₈F₁₇, LiSO₃C₉F₁₉, LiSO₃C₁₀F₂₁, LiSO₃C₁₁F₂₃, LiSO₃C₁₂F₂₅, NaSO₃CF₃, NaSO₃C₂F₅, NaSO₃C₃F₇, NaSO₃C₄F₉, NaSO₃C₅F₁₁, NaSO₃C₆F₁₃, NaSO₃C₇F₁₅, NaSO₃C₈F₁₇, NaSO₃C₉F₁₉, NaSO₃C₁₀F₂₁, NaSO₃C₁₁F₂₃, NaSO₃C₁₂F₂₅, Ca(SO₃CF₃)₂, Ca(SO₃C₂F₅)₂, Ca(SO₃C₃F₇)₂, Ca(SO₃C₄F₉)₂, Ca(SO₃C₅F₁₁)₂, Ca(SO₃C₆F₁₃)₂, Ca(SO₃C₇F₁₅)₂, Ca(SO₃C₈F₁₇)₂, Ca(SO₃C₉F₁₉)₂, Ca(SO₃C₁₀F₂₁)₂, Ca(SO₃C₁₁F₂₃)₂, Ca(SO₃C₁₂F₂₅)₂, (HSO₃)₂CF₂, (HSO₃)₂C₂F₄, (HSO₃)₂C₃F₆, (HSO₃)₂C₄F₈, (HSO₃)₂C₅F₁₀, (HSO₃)₂C₆F₁₂, (HSO₃)₂C₇F₁₄, (HSO₃)₂C₈F₁₆, (HSO₃)₂C₉F₁₈, (HSO₃)₂C₁₀F₂₀, (HSO₃)₂C₁₁F₂₂, (HSO₃)₂C₁₂F₂₄, (LiSO₃)₂CF₂, (LiSO₃)₂C₂F₄, (LiSO₃)₂C₃F₆, (LiSO₃)₂C₄F₈, (LiSO₃)₂C₅F₁₀, (LiSO₃)₂C₆F₁₂, (LiSO₃)₂C₇F₁₄, (LiSO₃)₂C₈F₁₆, (LiSO₃)₂C₉F₁₈, (LiSO₃)₂C₁₀F₂₀, (LiSO₃)₂C₁₁F₂₂, (LiSO₃)₂C₁₂F₂₄, (NaSO₃)₂CF₂, (NaSO₃)₂C₂F₄, (NaSO₃)₂C₃F₆, (NaSO₃)₂C₄F₈, (NaSO₃)₂C₅F₁₀, (NaSO₃)₂C₆F₁₂, (NaSO₃)₂C₇F₁₄, (NaSO₃)₂C₈F₁₆, (NaSO₃)₂C₉F₁₈, (NaSO₃)₂C₁₀F₂₀, (NaSO₃)₂C₁₁F₂₂, (NaSO₃)₂C₁₂F₂₄, Ca(SO₃)₂CF₂, Ca(SO₃)₂C₂F₄, Ca(SO₃)₂C₃F₆, Ca(SO₃)₂C₄F₈, Ca(SO₃)₂C₅F₁₀, Ca(SO₃)₂C₆F₁₂, Ca(SO₃)₂C₇F₁₄, Ca(SO₃)₂C₈F₁₆, Ca(SO₃)₂C₉F₁₈, Ca(SO₃)₂C₁₀F₂₀, Ca(SO₃)₂C₁₁F₂₂, Ca(SO₃)₂C₁₂F₂₄. Use is made, for example, of LiSO₃C₈F₁₇ or NaSO₃C₈F₁₇ or Ca(SO₃C₈F₁₇)₂. In accordance with a further specific embodiment, a stabilizer composition in accordance with the present invention comprises trifluoromethanesulfonic acid as at least one superacid, or a salt of trifluoromethanesulfonic acid as at least one salt of a superacid, such as Li trifluoromethanesulfonate, for example.

Provision is made, furthermore, to use derivatives of the sulfonic acids of the invention and derivatives of the sulfonic acid anions of the invention in which, where appropriate, some or all of the fluorine atoms have been replaced by other electron-withdrawing groups known to the skilled worker, such as NO₂ or OH, for example.

It is also possible and envisaged in accordance with the invention that a stabilizer composition comprises, as at least one compound from group B), for example, at least one superacid of the formula (F₂ₑ₊₁CₑSO₂)₂NH or a superacid of the formula (F₂ₑ₊₁CₑCO)₂NH, e in both formulae denoting an integer from 1 to 44, or comprises a fluorinated tetraphenylboric acid, or a polyfluoroalkoxyaluminic acid, or picric acid, or bis(oxalato)boric acid, or at least one salt of such a superacid.

A stabilizer composition in accordance with the present invention may accordingly, more particularly if one or more salts of inventively suitable superacids are used, comprise, for example, anions of the formula (F₂ₑ₊₁CₑSO₂)₂N— or anions of the formula (F₂ₑ₊₁CₑCO)₂N—, e in both formulae denoting an integer from 1 to 44, such as, for example, the bis(trifluoromethylsulfonyl)imide anion (CF₃SO₂)₂N—, or fluorinated tetraphenylborate anions such as, for example, tetrakis(3,5-bis(trifluoromethyl)phenylborate or perfluorotetraphenylborate, or polyfluoroalkoxyaluminate anions, or picrate anions 2,4,6-(NO)₂C₆H₂O—, or bis(oxalato)borate anions. Inventively suitable salts of such superacids comprise, for example, cations which derive from the elements Li, Na, K, Rb, Cs, Be, Mg, Ca, Sr, Ba, Al, Ga, In, Tl, Ge, Sn, Pb, Sb, the transition elements, the lanthanides, and the actinides, and also ammonium ions NH₄⁺ or organic onium ions, as described elsewhere in the context of the present text.

In the context of specific embodiments of the present invention, lithium salts of superacids of the invention are used, such as salts of imides of the formula (F₂ₑ₊₁CₑSO₂)₂NLi, or salts of the formula Li(CB₁₁A¹ᵤA²ᵥA³_{w}H_{(12-u-v-w)}), for example. In accordance with further embodiments, (CF₃SO₂)₂NLi, Li picrate, Li trifluoroacetate, LiN(COCF₃)₂, Li bis(trifluoromethylsulfonyl)imide, and Li bis(oxalato)borate are used.

In the context of further specific embodiments of the present invention, salts of superacids of the invention are used, examples being salts of imides of the formulae (F₂ₑ₊₁CₑSO₂)₂NNa, ((F₂ₑ₊₁CₑSO₂)₂N)₂Ca, and also of the corresponding onium salts and also of the corresponding onium salts. In accordance with further embodiments, (CF₃SO₂)₂NNa, ((CF₃SO₂)₂N)₂Ca, and the corresponding onium salts, Na picrate, Ca picrate, onium picrates, Na trifluoroacetate, Ca trifluoroacetate, onium trifluoroacetates, NaN(COCF₃)₂, Ca(N(COCF₃)₂)₂, and the corresponding onium salts, Na bis(trifluoromethylsulfoyl)imide, Ca di-bis(trifluoromethylsulfoyl)imide, and the onium bis(trifluoromethylsulfonyl)imides, Na bis(oxalato)borate, Ca di-bis(oxalato)borate, and also the onium bis(oxalato)borates are used.

Provision is also made, furthermore, to use derivatives of the aforementioned superacids of the invention and derivatives of the aforementioned anions of superacids of the invention, in which, where appropriate, some or all of the fluorine atoms have been replaced by other electron-withdrawing groups known to the skilled worker, such as NO₂ or OH, for example.

Superacids suitable in accordance with the invention, and the corresponding salts, can be prepared by methods known to the skilled worker. Li bis(oxalato)borate, for example, can be obtained by the method described by Xu et al. in Electrochemical and Solid-State Letters, 2001, 4, E1-E4, or by the process disclosed in DE-C-198 29 030. Furthermore, for example, U.S. Pat. No. 6,107,493 describes a process for preparing cyclic perfluoroalkanebis(sulfonyl)imides.

A stabilizer composition of the invention may comprise, for example, only one superacid or only one salt of a superacid. In the context of the present invention, though, it is also possible and envisaged for a stabilizer composition of the invention to comprise a mixture of two or more superacids or a mixture of two or more salts of superacids, or a mixture of at least one superacid and at least one salt of a superacid.

The superacids of the invention and their salts can be used in various common presentation forms, such as in the form of a salt or an aqueous solution applied to a suitable support material, for example. It is possible and envisaged in accordance with the invention to use at least one superacid or at least one salt of a superacid, or a mixture of two or more superacids or a mixture of two or more salts of superacids, or a mixture of at least one superacid and at least one salt of a superacid, in supported form on a suitable support material. Support materials suitable in accordance with the invention derive, for example, from organic or inorganic substances. Support materials preferred in accordance with the invention are, for example, crystalline or amorphous, natural or synthetic calcium silicates, hydrocalumites, zeolites, hydrotalcites, Ca(OH)₂, CaO, and PVC.

In the context of one specific embodiment of the present invention, for example, sodium perchlorate is used in supported form on a support material. In a further-preferred form, sodium perchlorate is used in supported form on Ca(OH)₂. Perchlorate presentation forms suitable in accordance with the invention are described in, for example, U.S. Pat. No. 5,034,443, whose disclosure relating to perchlorate presentation forms is expressly incorporated by reference, that disclosure being considered part of the disclosure content of the present text.

Further suitable presentation forms are given, for example, in EP-A 394,547, EP-A 457,471 and WO 94/24200, whose disclosure relating to suitable presentation forms is expressly incorporated by reference, that disclosure being considered part of the disclosure content of the present text.

The fraction of a superacid or of a salt of a superacid or of a mixture of two or more such acids and/or salts as a proportion of the stabilizer composition of the invention is about 0.005% to about 50% by weight, for example, about 0.01% to about 30% by weight or about 0.05% to about 20% by weight or about 0.1% to about 15% by weight or about 0.5% to about 10% by weight. Where a stabilizer composition of the invention comprises more than two constituents, the fraction of a superacid or of a salt of a superacid or of a mixture of two or more such acids and/or salts as a proportion of the stabilizer composition of the invention may be situated, for example, in the range from about 0.001% to about 20% by weight, for example, about 0.01% to about 15% by weight or about 0.05% to about 10% by weight or about 0.07% to about 5% by weight or about 0.09% to about 2% by weight, based in each case on the overall stabilizer composition.

Likewise suitable in accordance with the invention as at least one compound from the group B) are, for example, epoxy compounds. Examples of such epoxy compounds are epoxidized soy oil, epoxidized olive oil, epoxidized linseed oil, epoxidized castor oil, epoxidized peanut oil, epoxidized corn oil, epoxidized cottonseed oil, and glycidyl compounds.

Glycidyl compounds contain a glycidyl group attached directly to a carbon, oxygen, nitrogen or sulfur atom. Glycidyl or methylglycidyl esters are obtainable by reaction of a compound having at least one carboxyl group in the molecule with epichlorohydrin or glycerol dichlorohydrin or methyl-epichlorohydrin. The reaction takes place appropriately in the presence of bases.

Further details concerning glycidyl compounds suitable in accordance with the invention are included in WO 02/068526 A1 at page 20 line 22 to page 21 line 19. The stated publication, and more particularly the passage cited here, is incorporated by reference and considered part of the disclosure content of the present text.

Further terminal epoxides suitable in the context of the present invention as compounds from group B) are, for example, glycidyl 1-naphthyl ether, glycidyl 2-phenylphenyl ether, 2-diphenyl glycidyl ether, N-(2,3-epoxypropyl)phthalimide or 2,3-epoxypropyl 4-methoxyphenyl ether.

Likewise suitable are N-glycidyl compounds of the kind obtainable by dehydrochlorination of the reaction products of epichlorohydrin with amines which contain at least one amino hydrogen atom. Examples of such amines are aniline, N-methylaniline, toluidine, n-butylamine, bis(4-aminophenyl)methane, m-xylylenediamine or bis(4-methylaminophenyl)methane.

Likewise suitable are S-glycidyl compounds, examples being di-S-glycidyl ether derivatives which derive from dithiols such as ethane-1,2-dithiol or bis(4-mercaptomethylphenyl)ether.

Particularly suitable epoxy compounds are described for example in EP 1 046 668 A3 at pages 4 to 7, the disclosure contained therein being incorporated by reference and considered as part of the disclosure content of the present text.

Likewise suitable in accordance with the invention as at least one compound from group B) are, for example, 1,3-dicarbonyl compounds, more particularly the β-diketones and β-ketoesters. Suitability in the context of the present invention is possessed by dicarbonyl compounds of the general formula R′ C(O)CHR″—C(O)R′″, of the kind described for example at pages 7 to 9 of EP 1 046 668 A3, which, particularly as far as the radicals R′, R″, and R′″ are concerned, is incorporated by reference and whose disclosure is considered part of the disclosure content of the present text. Particularly suitable in this context are, for example, acetylacetone, butanoylacetone, heptanoylacetone, stearoylacetone, palmitoylacetone, lauroylacetone, 7-tert-nonylthioheptane-2,4-dione, benzoylacetone, dibenzoylmethane, lauroylbenzoylmethane, palmitoylbenzoylmethane, stearoylbenzoylmethane, isooctylbenzoylmethane, 5-hydroxycaproylbenzoylmethane, tribenzoylmethane, bis(4-methylbenzoyl)methane, benzoyl-p-chlorobenzoylmethane, bis(2-hydroxybenzoyl)methane, 4-methoxybenzoylbenzoylmethane, bis(4-methoxybenzoyl)methane, benzoylformylmethane, benzoylacetylphenylmethane, 1-benzoyl-1-acetylnonane, stearoyl-4-methoxybenzoylmethane, bis(4-tert-butylbenzoyl)methane, benzoylphenylacetylmethane, bis(cyclohexanoyl)methane, dipivaloylmethane, 2-acetylcyclopentanone, 2-benzoylcyclopentanone, methyl, ethyl, butyl, 2-ethylhexyl, dodecyl or octadecyl diacetoacetate, and also propionyl- or butyrylacetic esters having 1 to 18 C atoms, and also ethyl, propyl, butyl, hexyl or octyl stearoylacetate or polycyclic β-keto esters of the kind described in EP-A 433 230, incorporated by reference, or zinc chelates of the aforementioned compounds, provided they exist or dehydracetic acid and also its zinc, magnesium or alkali metal salts, or the alkali metal, alkaline earth metal.

1,3-Diketo compounds can be present in a stabilizer composition of the invention in an amount of up to about 20% by weight, for example, up to about 10% by weight.

Likewise suitable in accordance with the invention as at least one compound from group B) are, for example, polyols. In the context of the present invention the term “polyols” identifies organic compounds which have two or more OH groups per molecule. Examples of suitable polyols are pentaerythritol, dipentaerythritol, tripentaerythritol, bistrimethylolpropane, inositol, polyvinyl alcohol, bistrimethylolethane, trimethylolpropane, sorbitol, maltitol, isomaltitol, lactitol, lycasine, mannitol, lactose, leucrose, tris(hydroxyethyl)isocyanurate, palaitinitol, tetramethylolcyclohexanol, tetramethylolcyclopentanol, tetramethylolcycloheptanol, glycerol, diglycerol, polyglycerol, thiodiglycerol or 1-0-α-D-glycopyranosyl-D-mannitol dihydrate.

The polyols suitable in accordance with the invention as at least one compound from group B) may be present in a stabilizer composition of the invention in an amount of up to about 30% by weight, for example, up to about 10% by weight.

Likewise suitable as at least one compound from group B) are, for example, sterically hindered amines of the kind specified in EP 1 046 668 A3 on pages 11 to 35. The sterically hindered amines disclosed therein are incorporated by reference, the compounds identified therein being considered part of disclosure content of the present text.

The sterically hindered amines suitable in accordance with the invention as at least one compound from group B) may be present in a stabilizer composition of the invention in an amount of up to about 30% by weight, for example, up to about 10% by weight.

Additionally suitable as at least one compound from group B) are, for example, hydrotalcites, zeolites, and alkali metal aluminocarbonates. Suitable hydrotalcites, zeolites such as zeolite A and alkali metal aluminocarbonates are described for example in EP 1 046 668 A3 at pages 35 to 40, in EP-A 256 872 at pages 3, 5, and 7, in DE-C 41 06 411 at pages 2 and 3, or in DE-C 41 06 404 at pages 2 and 3. These publications are incorporated by reference and their disclosure at the passages cited is considered part of the disclosure content of the present text.

The hydrotalcites, zeolites, and alkali metal aluminocarbonates suitable in accordance with the invention as at least one compound from group B) may be present in a stabilizer composition of the invention in an amount of up to about 50% by weight, for example, up to about 30% by weight.

Likewise suitable as at least one compound from the group B) are, for example, hydrocalumites of the general formula XIV

M²⁺₍₂₊ₓ₎Al³⁺_{(1+y)}(OH)_{(6+z)}A^{k-}ₐ[Bₙ]ⁿ¹_{b}*m H₂O (XIV),

in which M is calcium, magnesium or zinc or mixtures of two of more thereof, A is a k-valent organic or inorganic acid anion, k is 1, 2 or 3, and B is an organic or inorganic acid anion other than A, n is an integer ≧1 and, where n>1, indicates the degree of polymerization of the acid anion, and 1 is 1, 2, 3 or 4 and indicates the valence of the acid anion, where if n=1 1 is 2, 3, or 4 and if n>1 1 indicates the valence of the individual monomer units of the polyanion and is 1, 2, 3 or 4, and n1 indicates the total valence of the polyanion, m identifies the amount of bound water, and the following rules apply for the parameters x, y, a, b, n, z, and k:
0≦x<0.6,
0≦y<0.4, and either x=0 or y=0,
0<a<0.8,
0<b<0.8/n, and
z=1+2x+3y−ka−n*1*b.

In formula (XIV), m identifies the amount of bound water, and m may vary, for example, as a function of the other chemical constituents of the hydrocalumites of the invention. For example, n may identify the amount of water of crystallization in a hydrocalumite of the invention. m may be adjusted, for example, as a function of the conditions during the preparation of the hydrocalumites of the invention, as for example through the choice of the temperature conditions prevailing during the preparation, or by heat treatment of hydrocalumites. The preparation of hydrocalumites suitable in accordance with the invention is known to the skilled worker and is described for example in DE 198 60 798 A1 at pages 5 to 6. The stated publication, and more particularly the passage cited here, is incorporated by reference and considered part of the disclosure content of the present text. A feature of hydrocalumites of the invention, for example, is that m is, for example, a number between 0 and about 40 or between 0 and about 20 or between 0 and about 12, for example, a number between about 1 and about 4 or between about 1.8 and about 3.2 or between about 2.1 and about 2.5.

In the context of one preferred embodiment of the present invention, compounds of the general formula XIV are used in which M is calcium, which where appropriate may be present in a mixture with magnesium or zinc, or magnesium and zinc.

With respect to hydrocalumites which can be used in accordance with the invention, DE 198 60 798 A1 and WO 02/068526 A1, at page 24 line 21 to page 26 line 12, contain further examples and also information on their preparation. The stated publications, and more particularly the passage of WO 02/068526 A1 that is cited here, are incorporated by reference and considered part of the disclosure content of the present text.

Hydrocalumites of the general formula XIV may be used in the context of the stabilizer compositions of the invention in an amount of up to about 50% by weight, for example, up to about 30% or up to about 15% by weight.

Additionally suitable as at least one compound from group B) are, for example, metal hydroxides, metal oxides, metal hydrogen carbonates and metal carbonates. As metal cations the metal hydroxides, metal oxides, metal hydrogen carbonates, and metal carbonates that are suitable in accordance with the invention have cations of preferably monovalent or divalent metals. Monovalent or divalent metals that are suitable in accordance with the invention are, for example, the alkali metals and alkaline earth metals and also zinc. Examples are LiOH, NaOH, KOH, Mg(OH)₂, Mg₅(CO₃)₄(OH)₂*2H₂O, Ca(OH)₂, Zn(OH)₂, MgO, CaO, ZnO, LiHCO₃, NaHCO₃, KHCO₃, Mg(HCO₃)₂, Ca(HCO₃)₂, Zn(HCO₃)₂, Li₂CO₃, Na₂CO₃, K₂CO₃, MgCO₃, CaCO₃, ZnCO₃.

A stabilizer composition of the invention may contain the stated metal hydroxides, metal oxides, metal hydrogen carbonates, and metal carbonates or a mixture of two or more thereof in an amount of up to about 50% by weight, as for example in an amount of up to about 30% by weight.

Likewise suitable as at least one compound from group B) are metal soaps of saturated, unsaturated, straight-chain or branched, aromatic, cycloaliphatic or aliphatic carboxylic acids or hydroxycarboxylic acids having preferably about 2 to about 22 C atoms. As metal cations, metal soaps have preferably a divalent cation, particular suitability being possessed by the cations of calcium or zinc or lead, or mixtures of two or more of these. In the context of one specific embodiment of the present invention, however, the stabilizer compositions of the invention are free from lead.

Examples of suitable carboxylic acid anions include anions of monovalent carboxylic acids such as acetic acid, propionic acid, butyric acid, valeric acid, hexanoic acid, enanthic acid, octanoic acid, neodecanoic acid, 2-ethylhexanoic acid, pelargonic acid, decanoic acid, undecanoic acid, dodecanoic acid, tridecanoic acid, myristic acid, palmitic acid, lauric acid, isostearic acid, stearic acid, 12-hydroxystearic acid, 9,10-dihydroxystearic acid, oleic acid, 3,6-dioxaheptanoic acid, 3,6,9-trioxadecanoic acid, behenic acid, benzoic acid, p-tert-butylbenzoic acid, dimethylhydroxybenzoic acid, 3,5-di-tert-butyl-4-hydroxybenzoic acid, tolylic acid, dimethylbenzoic acid, ethylbenzoic acid, n-propylbenzoic acid, salicylic acid, p-tert-octylsalicylic acid, sorbic acid, anions of divalent carboxylic acids and/or their monoesters, such as oxalic acid, malonic acid, maleic acid, tartaric acid, cinnamic acid, mandelic acid, malic acid, glycolic acid, oxalic acid, salicylic acid, polyglycoldicarboxylic acids having a degree of polymerization of about 10 to about 12, phthalic acid, isophthalic acid, terephthalic acid, or hydroxyphthalic acid, anions of trivalent or tetravalent carboxylic acids and/or their mono-, di- or triesters as in hemimellitic acid, trimellitic acid, pyromellitic acid or citric acid, and also, furthermore, so-called overbasic carboxylates of the kind described, for example, in DE-A 41 06 404 or DE-A 40 02 988, the disclosure of the last-mentioned documents being considered part of the disclosure content of the present text.

In the context of one preferred embodiment of the present invention, use is made as at least one compound from group B) of metal soaps whose anions derive from saturated or unsaturated carboxylic acids or hydroxycarboxylic acids having about 8 to about 20 C atoms. Particular preference in this context is given to stearates, oleates, laurates, palmitates, behenates, Versatates, hydroxystearates, dihydroxystearates, p-tert-butylbenzoates or (iso)octanoates of calcium or zinc or mixtures of two or more thereof. In the context of a further embodiment of the present invention, a stabilizer composition of the invention comprises calcium stearate or zinc stearate or a mixture thereof. In the context of one specific embodiment of the present invention, however, the stabilizer compositions of the invention are free from zinc.

The stabilizer composition of the invention may contain the stated metal soaps or a mixture of two or more thereof in an amount of up to about 50% by weight, for example, in an amount of up to about 30% by weight.

Additionally suitable as at least one compound from group B) are, for example, organotin compounds. Examples of suitable organotin compounds are methyltin-tris(isooctyl thioglycolate), methyltin-tris(isooctyl 3-mercaptopropionate), methyltin-tris(isodecyl thioglycolate), dimethyltin-bis(isooctyl thioglycolate), dibutyltin-bis(isooctyl thioglycolate), monobutyltin-tris(isooctyl thioglycolate), dioctyltin-bis(isooctyl thioglycolate), monooctyltin-tris(isooctyl thioglycolate) or dimethyltin-bis(2-ethylhexyl β-mercaptopropionate).

In the context of the stabilizer compositions of the invention it is possible, furthermore, to use the organotin compounds that are specified, and whose preparation is described, in EP-A 0 742 259 at pages 18 to 29. The abovementioned disclosure is incorporated by reference, the compounds specified therein and their preparation being understood as part of the disclosure content of the present text.

A stabilizer composition of the invention may comprise one of the described organotin compounds or a mixture of these in an amount of up to about 20% by weight, more particularly up to about 10% by weight.

Likewise suitable as at least one compound from group B) are organic phosphite esters having 1 to 3 radicals which are identical, identical in pairs or different. Examples of suitable organic radicals are linear or branched, saturated or unsaturated alkyl radicals having 1 to 24 C atoms, optionally substituted alkyl radicals having 6 to 20 C atoms or optionally substituted aralkyl radicals having 7 to 20 C atoms. Examples of suitable organic phosphite esters are tris(nonylphenyl), trilauryl, tributyl, trioctyl, tridecyl, tridodecyl, triphenyl, octyldiphenyl, dioctylphenyl, tri(octylphenyl), tribenzyl, butyldicresyl, octyldi(octylphenyl), tris(2-ethylhexyl), tritolyl, tris(2-cyclohexylphenyl), tri-α-naphthyl, tris(phenylphenyl), tris(2-phenylethyl), tris(dimethylphenyl), tricresyl or tris(p-nonylphenyl) phosphite or tristearyl sorbitol triphosphite or mixtures of two or more thereof.

A stabilizer composition of the invention may contain the described phosphite compounds in an amount of up to about 30% by weight, more particularly up to about 10% by weight, based in each case on the overall stabilizer composition.

Likewise suitable as at least one compound from the group B) are amino alcohols and hydroxyl-containing isocyanurates. Amino alcohols suitable in the context of the present invention are in principle all compounds which have at least one OH group and one primary, secondary or tertiary amino group or a combination of two or more of said amino groups. In principle, in the context of the present invention, suitability is possessed by not only solid but also liquid amino alcohols as a constituent of the stabilizer compositions of the invention.

Examples of amino alcohols suitable in accordance with the invention are OH-bearing derivatives of monoamino compounds having 2 to about 40, for example 6 to about 20, C atoms or of diamino compounds having 2 to about 40, for example 6 to about 20, C atoms or of triamino compounds having 2 to about 40, for example 6 to about 20, C atoms. Additionally possible for use in accordance with the invention are, for example, substituted amines having 2 to about 2° C. atoms.

Suitable OH-bearing derivatives of monoamines have, for example, one primary, one secondary or one tertiary amino group. Examples thereof are mono-, di- or triethylamine, mono-, di- or tri-n-propylamine, mono-, di- or triisopropylamine, mono-; di- or tri-sec-propylamine, mono-, di- or tri-n-butylamine, mono-, di- or tri-sec-butylamine, mono-, di- or tri-tert-butylamin or mono-, di- or trioctylamine, trimethylamine, N-methyl-, N-ethyl-, N-cyclohexylmorpholine, dimethylcyclohe-xylamine, dimethylbenzylamine, 1-azabicyclo[3.3.0]octane. Suitable OH-bearing derivatives of diamines are, for example, diamines having a molecular weight of about 32 to about 200 g/mol. Suitable OH-bearing derivatives of diamines have, for example, two primary, two secondary, two tertiary or one primary and one secondary or one primary and one tertiary or one secondary and one tertiary amino group. Examples thereof are diaminoethane, the isomeric diaminopropanes, the isomeric diaminobutanes, the isomeric diaminohexanes, piperazine, 2,5-dimethylpiperazine, amino-3-aminomethyl-3,5,5-trimethylcyclohexane (isophoronediamine, IPDA), 4,4′-diamino-dicyclohexylmethane, 1,4-diaminocyclohexane, aminoethylethanolamine, dimorpholinediethyl ether, 1,4-diazabicyclo[2.2.2]octane, N,N,N′,N′-tetra-methylethylenediamine, N,N,N′,N′-tetramethylbutanediamine, N,N,N′,N′-tetramethylhexane-1,6-diamine, tetramethyldiamino ethyl ether, 2-(N,N-dimethylamino)-1-aminoethane, di(4-N,N-dimethylaminocyclohexyl)methane, 1,2-dimethylimidazole, N,N′-dimethylpiperazine, hydrazine, hydrazine hydrate. Likewise suitable are OH-bearing derivatives of triamines. Such triamines have, for example, three primary, three secondary, three tertiary or two primary and one secondary or one tertiary, two secondary and one primary or tertiary, two tertiary and one primary or secondary. Examples thereof are diethylenetriamine, 1,8-diamino-4-aminomethyloctane, pentamethyldiethylenetriamine. Suitability is further possessed by, for example, bis(dimethylaminopropyl)urea.

Particularly suitable are aliphatic amino alcohols having 2 to about 40, preferably 6 to about 2° C. atoms, examples being 1-amino-3,3-dimethylpentan-5-ol, 2-aminohexane-2′,2″-diethanolamine, triethanolamine, triisopropanolamine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentanemethanol, 2-amino-2-ethyl-1,3-propanediol, 2-(dimethylaminoethoxy)ethanol, aromatic-aliphatic or aromatic-cycloaliphatic amino alcohols having 6 to about 2° C. atoms, the aromatic structures used being heterocyclic or isocyclic ring systems such as naphthalene derivatives or, in particular, benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol, and also mixtures of two or more such compounds.

In the context of one further embodiment of the present invention, use is made as amino alcohols of heterocyclic compounds which possess a cyclic ring system having amino groups, the OH groups being joined either directly to the ring or preferably via spacers to the ring. The invention envisages the use, for example, of heterocyclic amino alcohols which have at least 2, preferably at least 3, amino groups in the ring. Particularly suitable as the central ring constituent of the amino alcohols which can be used in accordance with the invention are in this case the trimerization products of isocyanates.

Particular preference is given in this context to hydroxyl-containing isocyanurates of the general formula XV

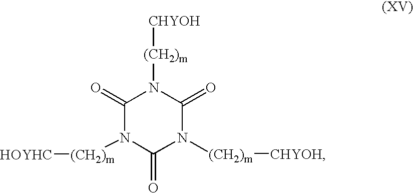

in which the groups Y and the indices m are each alike or different and m is an integer from 0 to 20, and Y is a hydrogen atom or a linear or branched, saturated or unsaturated alkyl group having 1 to about 10 C atoms. Particular preference is given in the context of the present invention to the use of tris(hydroxyethyl)isocyanurate (THEIC) as a constituent of the stabilizer compositions of the invention.

A stabilizer composition of the invention may comprise, for example, only one amino alcohol. Provision is likewise made in the context of the present invention, however, for a stabilizer composition of the invention to comprise a mixture of two or more different amino alcohols.

A stabilizer composition of the invention may contain an amino alcohol or a mixture of two or more amino alcohols in an amount of about 0.1% by weight to about 99.9% by weight or of about 0.2% by weight to about 80% by weight or of about 0.3% by weight to about 50% by weight or of about 0.4% by weight to about 30% by weight. If a stabilizer composition of the invention has more than two components, then the fraction of amino alcohol or amino alcohols may also lie, for example, in a range from about 0.1% by weight to about 25% by weight, for example, from about 0.2% by weight to about 20% by weight or from about 0.3% by weight to about 15% by weight or from about 0.5% by weight to about 10% by weight.

Additionally suitable as at least one compound from group B) are, for example, α,βunsaturated β-aminocarbonyl compounds having a structural element of the general formula XVI

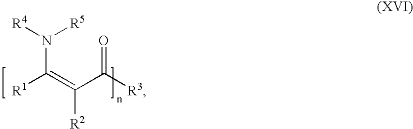

in which n is a number from 1 to 100 000, the radicals R¹, R², R⁴ and R⁵ each independently of one another are hydrogen, an optionally substituted, linear or branched, saturated or unsaturated aliphatic alkyl radical having from 1 to 44 C atoms, an optionally substituted, saturated or unsaturated cycloalkyl radical having 6 to 44 C atoms, or an optionally substituted aryl radical having 6 to 44 C atoms or an optionally substituted aralkyl radical having 7 to 44 C atoms, or the radical R¹ is an optionally substituted acyl radical having 2 to 44 C atoms, or the radicals R¹ and R² are joined to form an aromatic or heterocyclic system, and in which the radical R³ is hydrogen, an optionally substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having 1 to 44 C atoms, an optionally substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having 6 to 44 C atoms, or an optionally substituted aryl or arylene radical having 6 to 44 C atoms, or an ether or thioether radical having 1 to 20 O or S atoms or O and S atoms, or a polymer joined via O, S, NH, NR⁴ or CH₂C(O) to the structural element in brackets, or the radical R³ is joined to the radical R¹ in such a way as to form, overall, an optionally substituted, saturated or unsaturated heterocyclic ring system having 4 to 24 C atoms, or a mixture of two or more compounds of the general formula XVI.

In the context of one preferred embodiment of the present invention, use is made as a compound of the general formula XVI of a compound based on an α,β-unsaturated β-aminocarboxylic acid, more particularly on β-aminocrotonic acid. Particularly suitable in this context are the esters or thioesters of the corresponding aminocarboxylic acids with monofunctional or polyfunctional alcohols or mercaptans, R³ in the stated cases being in each case preferably an oxyalkyl or mercaptoalkyl radical.

If the radical R³ is an alcohol or mercaptan radical, such a radical may be formed, for example, from methanol, ethanol, propanol, isopropanol, butanol, 2-ethylhexanol, isooctanol, isononanol, decanol, lauryl alcohol, myristyl alcohol, palmityl alcohol, stearyl alcohol, ethylene glycol, propylene glycol, 1,3-butanediol, 1,4-butanediol, 1,6-hexanediol, 1,10-decanediol, diethylene glycol, thiodiethanol, trimethylolpropane, glycerol, tris(2-hydroxyethyl)isocyanurate, triethanolamine, pentaerythritol, ditrimethylolpropane, diglycerol, sorbitol, mannitol, xylitol, dipentaerythritol, and also the corresponding mercapto derivatives of the stated alcohols.

In the context of one particularly preferred embodiment of the present invention, use is made as a compound of the general formula XVI of a compound in which R¹ is a linear alkyl radical having 1 to 4 C atoms, R² is hydrogen, and R³ is a linear or branched, saturated, mono- to hexavalent alkyl or alkylene radical having 2 to 12 C atoms, or a linear, branched or cyclic divalent to hexavalent ether alcohol radical or thioether alcohol radical.

Suitable compounds of the general formula XVI include, for example, β-aminocrotonic acid stearyl ester, 1,4-butanediol-di(β-aminocrotonic acid) ester (BGAC), thiodiethanol-β-aminocrotonic acid ester, trimethylolpropane-tri-β-aminocrotonic acid ester, pentaerythritol-tetra-β-aminocrotonic acid ester, dipentaerythritol-hexa-β-aminocrotonic acid ester, and the like. In a stabilizer composition of the invention, the compounds stated may in each case be present alone or as a mixture of two or more thereof.

A stabilizer composition of the invention may contain an α,β-unsaturated β-aminocarbonyl compound or a mixture of two or more of the α,β-unsaturated β-aminocarbonyl compounds in an amount of about 0.1% to about 99.5% by weight, more particularly about 5% to about 50% by weight or about 5% to about 25% by weight, based in each case on the overall stabilizer composition.

Likewise suitable as at least one compound from group B) are aminouracil compounds and aminothiouracil compounds of the general formulae XVIIa and XVIIb

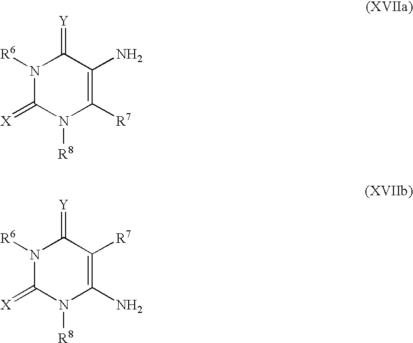

in which the radicals R₆ and R⁷ in each case independently of one another are hydrogen, an optionally substituted linear or branched, saturated or unsaturated aliphatic alkyl radical having 1 to 44 C atoms, an optionally substituted saturated or unsaturated cycloalkyl radical having 6 to 44 C atoms, or an optionally substituted aryl radical having 6 to 44 C atoms or an optionally substituted aralkyl radical having 7 to 44 C atoms, or the radical R⁶ is an optionally substituted acyl radical having 2 to 44 C atoms, or the radicals R⁶ and R⁷ are joined to form an aromatic or heterocyclic system, and the radical R⁸ is hydrogen, an optionally substituted linear or branched, saturated or unsaturated aliphatic hydrocarbon radical having 1 to 44 C atoms, an optionally substituted saturated or unsaturated cycloaliphatic hydrocarbon radical having 6 to 44 C atoms or an optionally substituted aromatic hydrocarbon radical having 6 to 44 C atoms, and X and Y in each case independently of one another are S or O.

In the context of a further specific embodiment of the present invention, use is made in the stabilizer compositions of the invention of compounds of the general formulae XVIIa and XVIIb in which R⁶ and R⁸ are a linear or branched alkyl radical having 1 to 8 C atoms, such as methyl, ethyl, propyl, butyl, pentyl, hexyl, heptyl or octyl, an OH-substituted linear or branched alkyl radical having 1 to 8 C atoms, such as hydroxymethyl, hydroxyethyl, hydroxypropyl, hydroxybutyl, hydroxypentyl or hydroxyhexyl, an aralkyl radical having 7 to 9 C atoms, such as benzyl, phenylethyl, phenylpropyl, dimethylbenzyl or phenylisopropyl, it being possible for the stated aralkyl radicals to be substituted, for example, by halogen, hydroxyl or methoxy, or an alkenyl radical having 3 to 6 C atoms, such as vinyl, allyl, methallyl, 1-butenyl or 1-hexenyl, for example.

In the context of one preferred embodiment of the present invention, use is made in the stabilizer compositions of the invention of compounds of the general formulae XVIIa and XVIIb in which R⁶ and R⁸ are hydrogen, methyl, ethyl, n-propyl, isopropyl, n-, iso-, sec-, tert-butyl or octyl.

Suitable in accordance with the invention as at least one compound from group B) are, for example, uracils of the general formulae XVIIa and XVIIb where X and Y are each O. Examples are 5-aminouracil, 5-amino-1,3-dimethyluracil, 5-amino-1,3-diethyluracil, 5-amino-1,3-di-n-propyluracil, 5-amino-1,3-di-n-butyluracil, 6-aminouracil, 6-amino-1,3-dimethyluracil, 6-amino-1,3-diethyluracil, 6-amino-1,3-di-n-propyluracil and 6-amino-1,3-di-n-butyluracil.

Likewise suitable in accordance with the invention as at least one compound from group B) are, for example, thiouracils of the general formulae XVIIa and XVIIb where X is S and Y is O. Examples are 5-amino-2-thiouracil, 5-amino-1,3-dimethyl-2-thiouracil, 5-amino-1,3-diethyl-2-thiouracil, 5-amino-1,3-di-n-butyl-2-thiouracil, 5-amino-1,3-di-n-octyl-2-thiouracil, 5-amino-1-methyl-3-n-butyl-2-thiouracil, 6-amino-2-thiouracil, 6-amino-1,3-dimethyl-2-thiouracil, 6-amino-1,3-diethyl-2-thiouracil, 6-amino-1,3-di-n-butyl-2-thiouracil, 6-amino-1,3-di-n-octyl-2-thiouracil, and 6-amino-1-methyl-3-n-butyl-2-thiouracil.

A stabilizer composition of the invention may contain a compound of the general formulae XVIIa and XVIIb or a mixture of two or more compounds of the general formulae XVIIa and XVIIb in an amount of about 0.1% to about 99.5% by weight, more particularly about 5% to about 50% by weight or about 5% to about 25% by weight, based in each case on the overall stabilizer composition.

Likewise suitable as at least one compound from group B) are, for example, compounds which have at least one mercapto-functional, sp²-hybridized C atom. Compounds which have at least one mercapto-functional, sp²-hybridized C atom are understood in the context of the present invention to be in principle all compounds which have a structural element Z¹=CZ²-SH or a structural element (Z¹H, Z²)C═S, it being possible for both structural elements to be tautomeric forms of a single compound. Z¹ and Z² denote substituted or unsubstituted organic radicals which, in combination with the mercapto-functional, sp²-hybridized C atoms, produce compounds of the invention which have at least one mercapto-functional, sp 2-hybridized C atom. Z¹ and Z² here may where appropriate be joined to one another and be part of a ring system. The sp²-hybridized C atom may be part of an optionally substituted aliphatic compound or part of an aromatic system. Examples of suitable types of compound are thiocarbamic acid derivatives, thiocarbamates, thiocarboxylic acids, thiobenzoic acid derivatives, thioacetone derivatives or thiourea or derivatives of thiourea. Suitable compounds having at least one mercapto-functional, sp²-hybridized C atom are specified for example in the German patent application with the file reference 101 09 366.7.

In the context of one preferred embodiment of the present invention the compound having at least one mercapto-functional, sp 2-hybridized C atom used is thiourea or a thiourea derivative.

A stabilizer composition of the invention may contain a compound which has at least one mercapto-functional, sp²-hybridized C atom in an amount of about 0.1% by weight to about 80% by weight, but preferably up to at most about 30% by weight, based in each case on the overall stabilizer composition. In the context of one preferred embodiment of the present invention a stabilizer composition of the invention contains about 1% by weight to about 25% by weight, for example, about 3% by weight to about 15% by weight or about 5% by weight to about 10% by weight of a compound which has at least one mercapto-functional, sp²-hybridized C atom.

A stabilizer composition of the invention comprising at least one compound from group A) and at least one compound from group B) can be used even without the addition of further additives for the purpose of stabilizing halogenated polymers. Frequently, however, it is advantageous, in order to optimize the stabilization capacity, to add further additives to these constituents. The present invention accordingly also provides a stabilizer composition which comprises at least one further additive. Suitable additives in accordance with the invention are, for example, lubricants, plasticizers, pigments, fillers, antioxidants, UV absorbers and light stabilizers or blowing agents, impact modifiers, and processing aids, gelling agents, antistats, biocides, metal deactivators, optical brighteners, flame retardants, and antifogging compounds, and also organic and inorganic solvents.

In addition it is possible for a stabilizer composition of the invention to comprise lubricants such as paraffin waxes, polyethylene waxes, polypropylene waxes, montan waxes, ester lubricants such as fatty acid esters, purified or hydrogenated natural or synthetic triglycerides or partial esters, amide waxes, chlorinated paraffins, glycerol esters or alkaline earth metal soaps. Lubricants which can be used are also described, furthermore, in “Kunststoffadditive”, R. Gächter/H. Müller, Carl Hanser Verlag, 3rd edition, 1989, pp. 478-488. Additionally suitable as lubricants, for example, are fatty ketones of the kind described in DE 4,204,887, and also silicone-based lubricants of the kind specified by EP-A 0 259 783 for example, or combinations thereof, as specified in EP-A 0 259 783. The stated documents are hereby incorporated by reference, their disclosure in relation to lubricants being considered part of the disclosure content of the present text. Particularly suitable in the context of the present invention are lubricants of the product range Baerolub® from the company Baerlocher GmbH (Unterschleiβheim, Germany).

A stabilizer composition of the invention may contain the described lubricants in an amount of up to about 70% by weight, more particularly up to about 55% by weight, based in each case on the overall stabilizer composition.

Likewise suitable as additives for stabilizer compositions in accordance with the present invention are organic plasticizers.

Examples of suitable plasticizers are compounds from the group of the phthalic esters, such as dimethyl, diethyl, dibutyl, dihexyl, di-2-ethylhexyl, di-n-octyl, diisooctyl, diisononyl, diisodecyl, dicyclohexyl, dimethylcyclohexyl, dimethyl glycol, dibutyl glycol, benzyl butyl or diphenyl phthalate, and also mixtures of phthalates, examples being mixtures of alkyl phthalates with 7 to 9 or 9 to 11 C atoms in the ester alcohol, or mixtures of alkyl phthalates with 6 to 10 and 8 to 10 C atoms in the ester alcohol. Particularly suitable in the sense of the present invention in this context are dibutyl, dihexyl, di-2-ethylhexyl, di-n-octyl, diisooctyl, diisononyl, diisodecyl, diisotridecyl, and benzyl butyl phthalate and also the stated mixtures of alkyl phthalates.

Additionally suitable as plasticizers are the esters of aliphatic dicarboxylic acids, more particularly the esters of adipic, azelaic or sebacic acid, or mixtures of two or more of them. Examples of such plasticizers are di-2-ethylhexyl adipate, diisooctyl adipate, diisononyl adipate, diisodecyl adipate, benzyl butyl adipate, benzyl octyl adipate, di-2-ethylhexyl azelate, di-2-ethylhexyl sebacate, and diisodecyl sebacate. Preference in the context of a further embodiment of the present invention is given to di-2-ethylhexyl acetate and diisooctyl adipate.

Likewise suitable as plasticizers are trimellitic esters such as tri-2-ethylhexyl trimellitate, triisotridecyl trimellitate, triisooctyl trimellitate, and also trimellitic esters having 6 to 8, 6 to 10, 7 to 9 or 9 to 11 C atoms in the ester group, or mixtures of two or more of the stated compounds.

Additionally suitable plasticizers are, for example, polymer plasticizers, as specified in “Kunststoffadditive”, R. Gächter/H. Müller, Carl Hanser Verlag, 3rd edition, 1989, section 5.9.6, pages 412-415, or “PVC Technology”, W. V. Titow, 4th edition, Elsevier Publishers, 1984, pages 165-170. The most common starting materials for the preparation of polyester plasticizers are, for example, dicarboxylic acids such as adipic, phthalic, azelaic or sebacic acid and also diols such as 1,2-propanediol, 1,3-butanediol, 1,4-butanediol, 1,6-hexanediol, neopentyl glycol or diethylene glycol, or mixtures of two or more of these.

Likewise suitable as plasticizers are phosphoric esters, as found in “Taschenbuch der Kunststoffadditive”, section 5.9.5, pp. 408-412. Examples of suitable phosphoric esters are tributyl phosphate, tri-2-ethylbutyl phosphate, tri-2-ethylhexyl phosphate, trichloroethyl phosphate, 2-ethylhexyl diphenyl phosphate, triphenyl phosphate, tricresyl phosphate or trixylenyl phosphate, or mixtures of two or more of these.

Additionally suitable as plasticizers are chlorinated hydrocarbons (paraffins) or hydrocarbons as described in “Kunststoffadditive”, R. Gächter/H. Müller, Carl Hanser Verlag, 3rd edition, 1989, section 5.9.14.2, pp. 422-425 and section 5.9.14.1, p. 422.

A stabilizer composition of the invention may contain the described plasticizers in an amount of up to about 99.5% by weight, more particularly up to about 30% by weight, up to about 20% by weight or up to about 10% by weight, based in each case on the overall stabilizer composition. In the context of one preferred embodiment of the present invention, the lower limit for the described plasticizers as a constituent of the stabilizer compositions of the invention is about 0.1% by weight or more, for example, about 0.5% by weight, 1% by weight, 2% by weight or 5% by weight, based in each case on the overall stabilizer composition.

Likewise suitable as a constituent of the stabilizer compositions of the invention are pigments. Examples of suitable inorganic pigments are titanium dioxide, carbon black, Fe₂O₃, Sb₂O₃, (Ba, Sb)O₂, Cr₂O₃, spinels such as cobalt blue and cobalt green, Cd (S, Se) or ultramarine blue. Examples of suitable organic pigments include azo pigments, phthalocyanine pigments, quinacridone pigments, perylene pigments, diketopyrrolopyrrole pigments or anthraquinone pigments.

A stabilizer composition of the invention may additionally comprise fillers, as described in “Handbook of PVC Formulating”, E. J. Wickson, John Wiley & Sons, Inc., 1993, on pages 393-449, or reinforcing agents, as described in “Taschenbuch der Kunststoffadditive”, R. Gächter/H. Müller, Carl Hanser Verlag, 1990, pages 549-615. Particularly suitable fillers or reinforcing agents are, for example, calcium carbonate (chalk), dolomite, wollastonite, magnesium oxide, magnesium hydroxide, silicates, glass fibers, talc, kaolin, chalk, carbon black or graphite, wood flour or other renewable raw materials. In the context of one preferred embodiment of the present invention a stabilizer composition of the invention comprises chalk.

In the context of a further embodiment of the present invention it is possible for the stabilizer compositions of the invention to comprise antioxidants, UV absorbers, and light stabilizers or blowing agents. Suitable antioxidants are described for example in EP 1 046 668 A3 on pages 47 to 51.

Suitable UV absorbers and light stabilizers are specified in EP 1 046 668 A3 on pages 51 to 53. Both disclosures are incorporated here by reference, the disclosures being considered part of the present text.

Examples of suitable blowing agents include organic azo compounds and hydrazo compounds, tetrazoles, oxazines, isatoic anhydride, salts of citric acid, such as ammonium citrate, and also soda and sodium bicarbonate. Particularly suitable are, for example, ammonium citrate, azodicarbonamide or sodium bicarbonate, or mixtures of two or more of these.

A stabilizer composition of the invention may further comprise impact modifiers and processing aids, gelling agents, antistats, biocides, metal deactivators, optical brighteners, flame retardants, and antifogging compounds. Suitable compounds of these classes of compound are described for example in “Kunststoff Additive”, R. Keβler/H. Müller, Carl Hanser Verlag, 3rd edition, 1989, and also in “Handbook of PVC Formulating”, E. J. Wilson, J. Wiley & Sons, 1993.

The stabilizer compositions of the invention are suitable, for example, for stabilizing halogenated polymers. The present invention accordingly further provides for the use of a compound from group A) or of a mixture of two or more of these compounds to stabilize halogenated polymers. According to one preferred embodiment the present invention provides for the use of 4-phenylsemicarbazide or a mixture of 4-phenylsemicarbazide and at least one further compound from group A) of the invention to stabilize halogenated polymers. According to a further preferred embodiment the present invention provides for the use of a stabilizer composition of the invention comprising at least one compound from group A) and at least one compound from group B) to stabilize halogenated polymers.

Examples of such halogenated polymers are polymers of vinyl chloride, vinyl resins containing vinyl chloride units in the polymer backbone, copolymers of vinyl chloride and vinyl esters of aliphatic acids, more particularly vinyl acetate, copolymers of vinyl chloride with esters of acrylic and methacrylic acid or acrylonitrile or mixtures of two or more of these, copolymers of vinyl chloride with diene compounds or unsaturated dicarboxylic acids or their anhydrides, examples being copolymers of vinyl chloride with diethyl maleate, diethyl fumarate or maleic anhydride, postchlorinated polymers and copolymers of vinyl chloride, copolymers of vinyl chloride and vinylidene chloride with unsaturated aldehydes, ketones, and other compounds such as acrolein, crotonaldehyde, vinyl methyl ketone, vinyl methyl ether, vinyl isobutyl ether, and the like, polymers and copolymers of vinylidene chloride with vinyl chloride and other polymerizable compounds, as already stated above, polymers of vinyl chloroacetate and dichlorodivinyl ether, chlorinated polymers of vinyl acetate, chlorinated polymeric esters of acrylic acid and of α-substituted acrylic acids, chlorinated polystyrenes, polydichlorostyrene for example, chlorinated polymers of ethylene, polymers and postchlorinated polymers of chlorobutadiene and copolymers thereof with vinyl chloride, and also mixtures of two or more of the stated polymers or polymer mixtures comprising one or more of the abovementioned polymers. In the context of one preferred embodiment of the present invention the stabilizer compositions of the invention are used to produce moldings from U such as window profiles, industrial profiles, pipes and panels.

Likewise suitable for stabilization with the stabilizer compositions of the invention are the graft polymers of PVC with EVA, ABS or MBS. Preferred substrates for such graft copolymers are, furthermore, the abovementioned homopolymers and copolymers, more particularly mixtures of vinyl chloride homopolymers with other thermoplastic or elastomeric polymers, more particularly blends with ABS, MBS, NBR, SAN, EVA, CPE, MBAS, PAA (polyalkyl acrylate), PAMA (polyalkyl methacrylate), EPDM, polyamides or polylactones.

Likewise suitable for stabilization with the stabilizer compositions of the invention are mixtures of halogenated and nonhalogenated polymers, examples being mixtures of the abovementioned nonhalogenated polymers with PVC, more particularly mixtures of polyurethanes and PVC.

Additionally it is possible to use the stabilizer compositions of the invention to stabilize recyclates of chlorinated polymers as well, with in principle all recyclates of the abovementioned halogenated polymers being suitable for this application. Suitable in the context of the present invention, for example, is PVC recyclate.

The present invention accordingly further provides a polymer composition at least comprising a halogenated polymer and a stabilizer composition of the invention.

In the context of one preferred embodiment of the present invention, a polymer composition of the invention contains the stabilizer composition of the invention in an amount of 0.1 to 20 phr, more particularly about 0.5 to about 15 phr or about 1 to about 12 phr. The unit phr stands for “per hundred resin” and hence relates to parts by weight per 100 parts by weight of polymer.

In the context of one further-preferred embodiment of the present invention, a polymer composition of the invention contains a compound from group A) in an amount of 0.01 to 10 phr or about 0.02 to about 5 phr or about 0.03 to about 2 phr or about 0.04 to about 1 phr or about 0.05 to 0.5 phr.

In the context of one further-preferred embodiment of the present invention, a polymer composition of the invention contains a compound from group B) in an amount of 0.001 to 10 phr or about 0.002 to about 5 phr or about 0.003 to about 2 phr or about 0.005 to about 1 phr or about 0.007 to about 0.8 phr or about 0.008 to about 0.6 phr.

A polymer composition of the invention preferably comprises as halogenated polymer, at least proportionally, PVC, the proportion of PVC being more particularly at least about 20%, preferably at least about 50% by weight, for example, at least about 80% or at least about 90% by weight, based in each case on the overall polymer composition.

The present invention also provides a method of stabilizing halogenated polymers, wherein a halogenated polymer or a mixture of two or more halogenated polymers or a mixture of one or more halogenated polymers and one or more halogen-free polymers is mixed with a stabilizer composition of the invention.

The mixing of polymers or polymers and the stabilizer composition of the invention may in principle take place at any desired point in time before or during the processing of the polymer. Thus, for example, the stabilizer composition can be admixed, prior to processing, to the polymer present in powder or granule form. It is also possible, however, to add the stabilizer composition to the polymer or polymers in the softened or melted state, as for example during processing in an extruder, as an emulsion or as a dispersion, as a pasty mixture, as a dry mixture, as a solution or melt.

The present invention accordingly also provides a method of stabilizing halogenated polymers, wherein a halogenated polymer or a mixture of two or more halogenated polymers or a mixture of one or more halogenated polymers and one or more halogen-free polymers is mixed with a stabilizer composition of the invention.

A polymer composition of the invention can be brought in a known way into a desired form. Suitable methods are, for example, calendering, extruding, injection molding, sintering, extrusion blow molding, or the plastisol method. A polymer composition of the invention may also be used, for example, to produce foams. In principle the polymer compositions of the invention are suitable for producing unplasticized or plasticized PVC, more particularly for producing U.

A polymer composition of the invention can be processed to moldings. The present invention accordingly also provides moldings at least comprising a stabilizer composition of the invention or a polymer composition of the invention.

The term “molding” in the context of the present invention encompasses in principle all three-dimensional structures which can be produced from a polymer composition of the invention. In the context of the present invention the term “molding” encompasses, for example, wire sheathing, automobile components, examples being automobile components of the kind used in the interior of the automobile, in the engine compartment or on the outsides, cable insulation, decorative films, agricultural films, hoses, sealing profiles, office films, hollow bodies (bottles), packaging films (thermoforming films), blown films, tubes, foams, heavy profiles (window frames), light-wall profiles, construction profiles, sidings, fittings, panels, foam slabs, coextrudates with a recycled core or housings for electrical apparatus or machines for example, computers or household appliances.

Further examples of moldings that can be produced from a polymer composition of the invention are synthetic leathers, floorcoverings, textile coatings, wallpapers, coil coatings or underbody protection for motor vehicles.

The invention is illustrated below by examples.

### EXAMPLES

### 1) Polymer Composition

| | Inventive | Comparative |
|---|---|---|
| | example | example |
| PVC (K value 65) | 100.00 | 100.00 |
| Chalk | 5.00 | 5.00 |
| Ceasit (Ca stearate) | 0.60 | 0.60 |
| Microwax | 0.50 | 0.50 |
| PE wax | 0.50 | 0.50 |
| Ca(OH)₂ | 0.10 | 0.10 |
| BS RB 3061 (Ca Al phosphite) | 0.60 | 0.60 |
| BS ASM 711 (NaClO₄ | 0.10 | 0.10 |
| on Ca(OH)₂) | | |
| 4-Phenylsemicarbazide | 0.10 | — |

All quantities relate to 100 parts of PVC [phr—per hundred resin]

### 2) Result

The polymer composition of the invention is distinguished by an outstanding initial color and excellent color maintenance. In terms of both properties it is superior to the polymer composition in accordance with the comparative example.

What is claimed is:

1. A stabilizer composition for stabilizing halogenated polymers, comprising at least one compound from group A) and at least one compound from group B), group A) being composed of
a1) semicarbazides and their salts,
a2) carbazides and their salts,
a3) carbazones and their salts and
a4) carbodiazones and their salts,
and group B) being composed of
b1) guanidines and melamines,
b2) superacids and salts of superacids,
b3) epoxy and glycidyl compounds,
b4) 1,3-dicarbonyl compounds,
b5) polyols,
b7) hydrotalcites, zeolites, and alkali metal aluminocarbonates,
b8) hydrocalumites,
b9) metal hydroxides, metal oxides, metal hydrogen carbonates, and metal carbonates,
b10) metal soaps,
b11) organotin compounds,
b12) organic phosphite esters,
b13) amino alcohols and hydroxyl-containing isocyanurates,
b14) α,β-unsaturated β-aminocarbonyl compounds,
b15) aminouracil compounds and aminothiouracil compounds, and
b16) compounds having at least one mercapto-functional, sp²-hybridized C atom.

2. The stabilizer composition of claim 1 wherein at least one compound from group A) is a 4-phenylsemicarbazide derivative.

3. The stabilizer composition of claim 1 wherein at least one compound from group A) is 4-phenylsemicarbazide.

4. The stabilizer composition of claim 1 wherein at least one superacid has a ΔG_{acid} of less than or equal to 316 kcal/mol.

5. The stabilizer composition of claim 1 wherein at least one superacid is a halogen containing oxyacid or at least one salt of a superacid is a salt of a halogen containing oxyacid.

6. The stabilizer composition of claim 1 wherein at least one superacid is a perchloric acid or at least one salt of a superacid is a salt of a perchloric acid.

7. The stabilizer composition of claim 1 wherein at least one salt of a superacid is sodium perchlorate.

8. The stabilizer composition of claim 1 wherein at least one salt of a superacid is sodium perchlorate, the sodium perchlorate being present in supported form on a support material.

9. The stabilizer composition of claim 8 wherein the support material is Ca(OH)₂.

10. The stabilizer composition of claim 1 wherein at least one superacid is a sulfonic acid or at least one salt of a superacid is a salt of a sulfonic acid.

11. The stabilizer composition of claim 1 wherein at least one superacid is an alkylsulfonic acid or at least one salt of a superacid is a salt of an alkylsulfonic acid.

12. The stabilizer composition of claim 1 wherein at least one superacid is a trifluoromethanesulfonic acid or at least one salt of a superacid is a salt of trifluoromethanesulfonic acid.

13. The stabilizer composition of claim 1 wherein at least one superacid is an acid of the formula (F₂ₑ₊₁CₑSO₂)₂NH or an acid of the formula (F₂ₑ₊₁CₑCO)₂NH, e in both formulae denoting an integer from 1 to 44, or is a fluorinated tetraphenylboric acid, or a polyfluoroalkoxyaluminic acid, or picric acid, or bis(oxalato)boric acid, or at least one salt of a superacid is a salt of such a superacid.

14. The stabilizer composition of claim 1 wherein it comprises at least one additive.

15. The use of a compound from group A) or of a mixture of two or more of these compounds to stabilize halogenated polymers.

16. The use of claim 15 wherein 4-phenylsemicarbazide is used as compound from group A) or a mixture of 4-phenylsemicarbazide and at least one further compound from group A) is used as a mixture of two or more compounds from group A) to stabilize halogenated polymers.

17. A polymer composition at least comprising a halogenated polymer and a stabilizer composition of claim 1.

18. A method of stabilizing halogenated polymers, wherein a halogenated polymer or a mixture of two or more halogenated polymers or a mixture of one or more halogenated polymers and one or more halogen-free polymers is mixed with a stabilizer composition of claim 1.

19. A molding at least comprising a stabilizer composition of claim 1 or a polymer composition of claim 17.
